(19) United States
(12) Patent Application Publication
(10) Pub. No.: US 2024/0094020 A1
(43) Pub. Date: Mar. 21, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: NOBUKI FURUE, TOKYO (JP); FUMIKO TOTSUKA, TOKYO (JP); OSAMU SAKURAI, TOKYO (JP); TERUYOSHI MASUDA, TOKYO (JP)

(21) Appl. No.: 17/754,694

(22) PCT Filed: Oct. 2, 2020
(86) PCT No.: PCT/JP2020/037530

§ 371 Date: Apr. 8, 2022

(30) Foreign Application Priority Data
Oct. 17, 2019 (JP) 2019-190230

(51) Int. Cl. G01C 21/36; G06T 11/00; H04N 7/18; H04N 23/661

(52) U.S. Cl. CPC G01C 21/3611; G06T 11/00; H04N 7/181; H04N 23/661; G06Q 10/02

(57) ABSTRACT

The present technology relates to an information processing apparatus, an information processing method, and a program enabling to obtain an image that gives high satisfaction. An information processing apparatus includes: a control unit configured to control to display an image-capturing sample image list in which a plurality of image-capturing sample images captured at a plurality of image-capturing places different from each other is arranged, and to control to present guide information for guidance to an image-capturing place of a selected image-capturing sample image in a case where any of the image-capturing sample images is selected from the image-capturing sample image list. The present technology can be applied to an image-capturing system.

### TECHNICAL FIELD

The present technology relates to an information processing apparatus, an information processing method, and a program, and particularly relates to an information processing apparatus, an information processing method, and a program capable of obtaining an image that gives high satisfaction.

### BACKGROUND ART

For example, when a user visits a sightseeing spot or a commercial facility, the user often wants to capture and save an image at that time.

Therefore, for example, there has been proposed a photographing system that detects a position of a user who has made a reservation for photographing in a facility, and photographs an image in accordance with the reservation in a case where the user is present at a predetermined position (see, for example, Patent Document 1). In such a photographing system, a user can obtain an image of the self as a subject without having a photographing device.

### CITATION LIST

### Patent Document

Patent Document 1: Japanese Patent Application Laid-Open No. 2004-297191

### SUMMARY OF THE INVENTION

### Problems to be Solved by the Invention

However, in the technology described above, a user can select a photographing position at the time of the reservation of photographing, but it is difficult to imagine what kind of image can be obtained until the user actually goes to the reserved photographing position or receives an actually photographed image. Therefore, an image that can satisfy the user may not necessarily be obtained.

The present technology has been made in view of such a situation, and is to make it possible to obtain an image that gives high satisfaction.

### Solutions to Problems

An information processing apparatus according to a first aspect of the present technology includes: a control unit configured to control to display an image-capturing sample image list in which a plurality of image-capturing sample images captured at a plurality of image-capturing places different from each other is arranged, the control unit being configured to control to present guide information for guidance to an image-capturing place among the image-capturing places, the image-capturing place being of a selected image-capturing sample image among the image-capturing sample images in a case where any of the image-capturing sample images is selected from the image-capturing sample image list.

An information processing method or a program according to the first aspect of the present technology includes: a step of controlling to display an image-capturing sample image list in which a plurality of image-capturing sample images captured at a plurality of image-capturing places different from each other is arranged, and controlling to present guide information for guidance to an image-capturing place among the image-capturing places, the image-capturing place being of a selected image-capturing sample image among the image-capturing sample images in a case where any of the image-capturing sample images is selected from the image-capturing sample image list.

In the first aspect of the present technology, an image-capturing sample image list is displayed in which a plurality of image-capturing sample images captured at a plurality of image-capturing places different from each other is arranged, and guide information for guidance to an image-capturing place among the image-capturing places is presented, the image-capturing place being of a selected image-capturing sample image among the image-capturing sample images in a case where any of the image-capturing sample images is selected from the image-capturing sample image list.

An information processing apparatus according to a second aspect of the present technology includes: a control unit configured to generate an image-capturing sample image list in which a plurality of image-capturing sample images is arranged on the basis of a plurality of the image-capturing sample images captured at a plurality of image-capturing places different from each other; and a communication unit configured to transmit, to a terminal device, data for guidance to an image-capturing place among the image-capturing places, the image-capturing place being of a selected image-capturing sample image among the image-capturing sample images in a case where any of the image-capturing sample images is selected from the image-capturing sample image list, in the terminal device that is a transmission destination of the image-capturing sample image list.

An information processing method or a program according to the second aspect of the present technology includes steps of: generating an image-capturing sample image list in which a plurality of image-capturing sample images is arranged on the basis of a plurality of the image-capturing sample images captured at a plurality of image-capturing places different from each other; and transmitting, to a terminal device, data for guidance to an image-capturing place among the image-capturing places, the image-capturing place being of a selected image-capturing sample image among the image-capturing sample images in a case where any of the image-capturing sample images is selected from the image-capturing sample image list, in the terminal device that is a transmission destination of the image-capturing sample image list.

In the second aspect of the present technology, an image-capturing sample image list is generated in which a plurality of image-capturing sample images is arranged on the basis of a plurality of the image-capturing sample images captured at a plurality of image-capturing places different from each other; and data for guidance to an image-capturing place among the image-capturing places is transmitted to a terminal device, the image-capturing place being of a selected image-capturing sample image among the image-capturing sample images in a case where any of the image-capturing sample images is selected from the image-capturing sample image list, in the terminal device that is a transmission destination of the image-capturing sample image list.

### BRIEF DESCRIPTION OF DRAWINGS

FIG. 1 is a diagram illustrating a configuration example of an image-capturing system.

FIG. 2 is a view for explaining an image-capturing service.

FIG. 3 is a view for explaining the image-capturing service.

FIG. 4 is a view for explaining the image-capturing service.

FIG. 5 is a view for explaining the image-capturing service.

FIG. 6 is a view for explaining the image-capturing service.

FIG. 7 is a view for explaining the image-capturing service.

FIG. 8 is a view for explaining the image-capturing service.

FIG. 9 is a view for explaining the image-capturing service.

FIG. 10 is a block diagram illustrating a configuration example of a server.

FIG. 11 is a diagram for explaining information recorded in the server.

FIG. 12 is a diagram illustrating a configuration example of a user terminal device.

FIG. 13 is a flowchart for explaining selection processing and guide image list provision processing.

FIG. 14 is a flowchart for explaining image-capturing start instruction processing and image-capturing control processing.

FIG. 15 is a flowchart for explaining captured image acquisition processing and captured image provision processing.

FIG. 16 is a flowchart for explaining selection processing and guide image list provision processing.

FIG. 17 is a flowchart for explaining image-capturing start instruction processing and image-capturing control processing.

FIG. 18 is a diagram illustrating a configuration example of a computer.

### MODE FOR CARRYING OUT THE INVENTION

Hereinafter, embodiments to which the present technology is applied will be described with reference to the drawings.

### First Embodiment

<Configuration Example of Image-Capturing System>

The present technology enables to easily obtain an image that gives high satisfaction, by presenting, to a user, a list of images actually captured with another user as a subject.

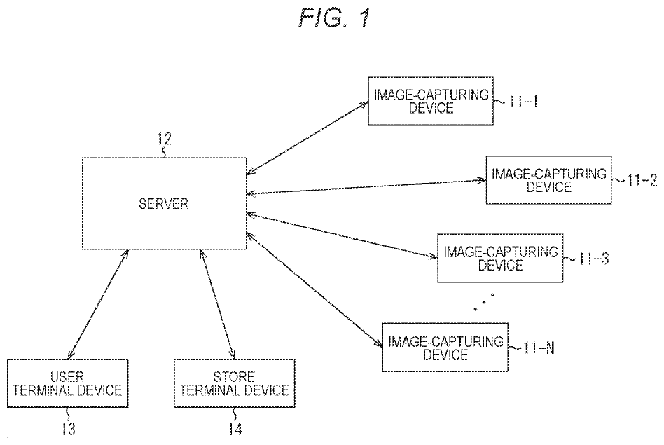

FIG. 1 is a diagram illustrating a configuration example of an embodiment of an image-capturing system to which the present technology is applied.

The image-capturing system illustrated in FIG. 1 includes image-capturing devices 11-1 to 11-N, a server 12, a user terminal device 13, and a store terminal device 14.

The image-capturing devices 11-1 to 11-N include, for example, cameras, and are fixed and installed at a plurality of image-capturing places different from each other. Hereinafter, the image-capturing devices 11-1 to 11-N will also be simply referred to as an image-capturing device 11 in a case where it is not particularly necessary to distinguish from each other.

An area where a user can go around in one day, such as, for example, a sightseeing spot, an indoor or outdoor commercial facility, or an outdoor walk area, is set as a target area, and the image-capturing devices 11 are installed at mutually different locations in the target area.

Specifically, for example, the image-capturing device 11 is installed at various locations such as a place suitable for image capturing in a tourist spot such as a park in the target area, in a store such as a restaurant, a general store, or a clothing store in the target area, and a classroom of a school or a lesson. Then, a location where the image-capturing device 11 is installed is an image-capturing place.

For example, it is conceivable to use, as the image-capturing device 11, a monitoring camera installed at an image-capturing place, a camera installed by a local government or the like having a sightseeing spot, a camera of another user in a sightseeing spot or the like, and the like.

Here, an example is described in which one image-capturing device 11 is installed for one image-capturing place, but a plurality of image-capturing devices 11 may be installed at mutually different locations for one image-capturing place. In such a case, images with a plurality of mutually different angles of view (angles) are obtained at one image-capturing place.

In accordance with control of the server 12, the image-capturing device 11 captures an image (hereinafter referred to as a captured image) in which a user who uses the image-capturing system is a subject, and supplies the obtained captured image to the server 12. Note that the captured image may be a still image or a moving image.

The server 12 controls the image-capturing device 11 to capture a captured image in response to a request from the user terminal device 13, and provides the user terminal device 13 with a captured image obtained by image capturing.

Furthermore, the server 12 communicates with the store terminal device 14 in response to a request from the user terminal device 13, and reserves service provision for the user at a store where the image-capturing device 11 is installed.

The user terminal device 13 includes, for example, an information processing apparatus such as a smartphone or a tablet owned by a user who uses an image-capturing service provided by the image-capturing system.

The user terminal device 13 requests the server 12 to reserve image capturing by the image-capturing device 11, and receives provision of a captured image obtained by image capturing from the server 12, in response to a user's operation.

The store terminal device 14 includes, for example, an information processing apparatus such as a personal computer managed by a store such as a restaurant where the image-capturing device 11 is installed, communicates with the server 12, and performs processing related to a reservation of the user.

Note that, in the following, in order to facilitate understanding of the description, the description will be continued assuming that the store terminal device 14 manages a reservation of eating and drinking by a user at a restaurant where the image-capturing device 11 is installed.

Furthermore, here, an example is described in which only one store terminal device 14 is provided in the image-capturing system, but a plurality of store terminal devices 14 may be provided as a matter of course.

Similarly, although only one user terminal device 13 is illustrated in FIG. 1, there is actually a plurality of users who uses the image-capturing service, and the user terminal device 13 exists for the every user.

Moreover, an example has been described here in which the number of target areas where the image-capturing device 11 is installed is one, but there may be a plurality of target areas, and control (management) for capturing of a captured image may be performed for the every target area.

<About Image-Capturing Service>

Next, an outline of an image-capturing service provided by the image-capturing system illustrated in FIG. 1 will be described. In particular, it is assumed here that the target area is a sightseeing spot.

For example, when a user arrives at a sightseeing spot and visits a tourist information center, the user causes the user terminal device 13 to download an application program necessary for an image-capturing service by reading a presented quick response (QR) code.

Note that, without limiting to this, the user may cause the user terminal device 13 to download the application program in any way, and a download timing of the application program can be set to any timing.

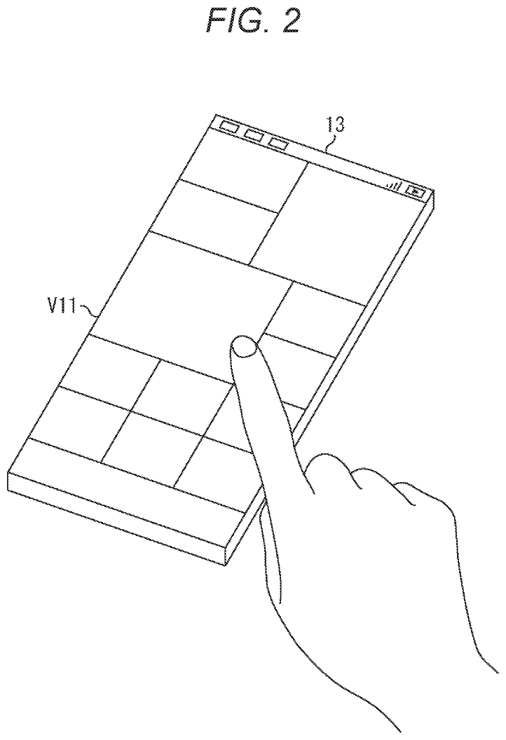

When the user operates the user terminal device 13 to start the application program, for example, a guide image list V11 illustrated in FIG. 2 is displayed on the user terminal device 13.

In the guide image list V11, captured images actually captured by the image-capturing device 11 with various users as subjects are arranged and displayed as guide images.

In particular, in the guide image list V11, a plurality of guide images captured at a plurality of image-capturing places different from each other is arranged and displayed, in an order and a size according to an appearance of these guide images, a degree of popularity of the image-capturing places, and the like.

For example, in a case where the guide image is a moving image, more specifically, a thumbnail image of a moving image, the user may select the guide image to perform stream reproduction on the moving image as the guide image.

The guide image on the guide image list V11 is an image that introduces an image-capturing place where the guide image has been actually captured, that is, an image-capturing spot or a restaurant.

While viewing the plurality of guide images displayed as a list, the user selects an image-capturing place that the self wants to actually go to, that is, a guide image that the self wants to capture an image.

Note that, hereinafter, the guide image selected by the user from the guide image list is also particularly referred to as a selected guide image.

In particular, here, by selecting a preferred guide image from the guide image list V11, the user can specifically imagine and select a place where the self wants to actually go to and capture an image.

Moreover, at each image-capturing place, since image capturing is performed by the fixed image-capturing device 11, the user can obtain a captured image having the same angle of view (angle) as that of the guide image selected from the guide image list V11. That is, it is possible to obtain a captured image close to the guide image selected by the self.

Moreover, the user can also refer to posing of another user in the guide image at the time of image capturing of the captured image.

In this way, if the user goes to the image-capturing place of the guide image selected from the guide image list V11 and captures a captured image with the image-capturing device 11, the user can obtain a captured image close to that imagined by the self, that is, an image that gives high satisfaction.

Therefore, it can be said that the guide image is not only an image that introduces the image-capturing place as described above, but also an image-capturing sample image serving as an image-capturing sample (an image-capturing example) of the captured image that the user will obtain, that is, a creation example image that is a creation example of the captured image.

As described above, the user selects one or a plurality of guide images as a selected guide image from among a plurality of guide images displayed as a list in the guide image list V11.

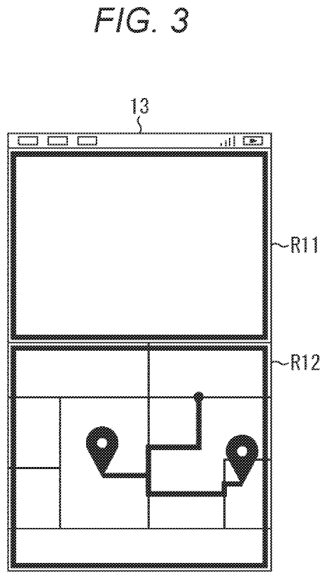

Then, for example, as illustrated in FIG. 3, the user terminal device 13 displays a display screen provided with an image display region R11 where a selected guide image selected by the user is displayed, and a map display region R12 where a map is displayed, in which the map is an image for guidance of the user to the image-capturing place where the selected guide image is captured.

For example, by operating the selected guide image displayed in the image display region R11, the user can reproduce a moving image as the selected guide image.

Furthermore, for example, by performing a swipe operation on the selected guide image in the image display region R11, the user can control to display another selected guide image or display another guide image captured at an image-capturing place same as that of the selected guide image.

In the map display region R12, a map indicating a route from a current location of the user (the user terminal device 13) to the image-capturing place of the selected guide image is displayed. Here, for example, marks indicating the current location of the user and the image-capturing place of the selected guide image are displayed on the map, and the user can instantaneously grasp a locational relationship between the current location and the image-capturing place.

Note that, here, an example will be described in which map information is presented as guide information for guidance of the user to the image-capturing place. However, without limiting to this, any guide information to be presented to the user may be adopted, such as, voice information for guidance of (guiding) the user to the image-capturing place, an image (AR image) of AR display such as an arrow that guides the user to the image-capturing place and is superimposed and displayed on an image captured with surroundings of the user terminal device 13 as a subject, and a combination of audio information and image information. Furthermore, the guide information may be presented on a device different from the user terminal device 13, such as a terminal device at a tourist information center.

After selecting the selected guide image, the user heads to the actual image-capturing place on foot or the like while referring to the map and the like displayed in the map display region R12.

Then, when the user, that is, the user terminal device 13 comes into a state of being located near the image-capturing place of the selected guide image, for example, a screen prompting to hold the user terminal device 13 toward a direction of the image-capturing place (the image-capturing spot) is displayed on the user terminal device 13.

When the user holds the user terminal device 13 toward the image-capturing place, the user terminal device 13 captures an environment image of the surroundings of the user terminal device 13 as a subject. This environment image includes the image-capturing place as a subject.

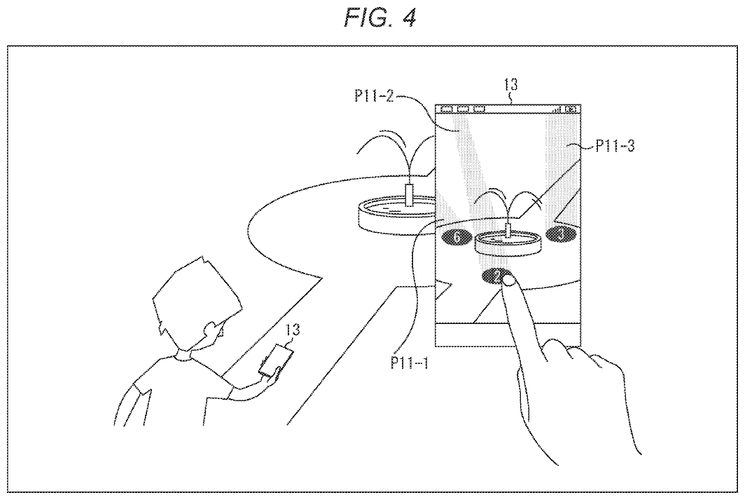

As a result, in the user terminal device 13, for example, as illustrated in FIG. 4, the environment image and augmented reality (AR) images P11-1 to P11-3 superimposed on the environment image are displayed.

In this example, the AR images P11-1 to P11-3 are images indicating: a location of the image-capturing place corresponding to the selected guide image; an angle of view at the time of image capturing of the captured image at the image-capturing place; and the number of persons waiting for image capturing at the image-capturing place.

Specifically, in the environment image, for example, the AR image P11-1 is displayed at a location on a left rear side in the figure of a fountain existing in a real space, and the display location indicates an image-capturing place, that is, an outdoor image-capturing spot. Furthermore, the entire region of the AR image P11-1 represents a region within an angle of view of the captured image, that is, a region of an image-capturing visual field of the image-capturing device 11.

Therefore, by viewing the AR image P11-1 superimposed and displayed on the environment image, the user can instantaneously grasp where the image-capturing spot is, and at what angle of view (angle) the image capturing is performed at the image-capturing spot.

Moreover, the number “6” described in the AR image P11-1 indicates the number of other users waiting for image capturing at the image-capturing spot (the image-capturing place) corresponding to the AR image P11-1, that is, the number of image-capturing waiting users. Therefore, by viewing the AR image P11-1, the user can roughly know how long a waiting time is before a turn of the self for the image capturing comes.

Note that, although the example has been described here in which the number of persons waiting for image capturing is displayed in the AR image, a waiting time or the like for image capturing may be displayed.

Hereinafter, a state where the user holds the user terminal device 13 toward the image-capturing place to display the environment image and the AR image is also referred to as an AR display state.

For example, by operating the user terminal device 13 in the AR display state, the user can reserve image capturing of a captured image at an image-capturing place (an image-capturing spot) corresponding to the AR image.

Note that, here, an example in which a reservation of the image-capturing is performed in the AR display state is described. However, the reservation of the image-capturing may be performed at any timing, such as when the selected guide image, the map to the image-capturing place, and the like are displayed as illustrated in FIG. 3, for example.

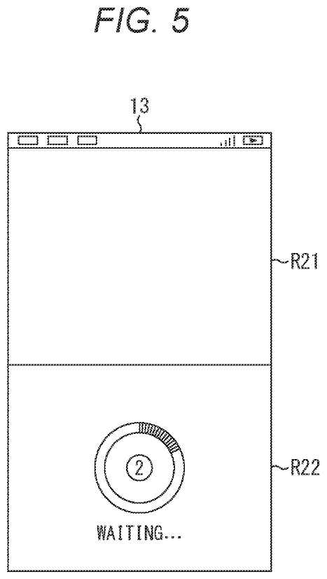

When the user reserves image capturing at a desired image-capturing spot (image-capturing place), a streaming screen is displayed on the user terminal device 13 as illustrated in FIG. 5, for example.

In the example of FIG. 5, a streaming image is displayed in an image display region R21 on an upper side in the figure of the streaming screen on the user terminal device 13.

The streaming image displayed in the image display region R21 is, for example, a moving image showing a current state of image capturing or the like at an image-capturing spot for which image capturing is reserved by the user, a moving image for explaining image capturing at the image-capturing spot, a moving image of a creation example prepared in advance, or the like.

Note that a user experience at a time of image capturing at an image-capturing spot (an image-capturing place) such as, for example, an effect on a captured image or a user interface (UI) screen displayed at the time of image capturing may be different for every image-capturing spot or for every target area such as a sightseeing spot.

For example, if a current state of the image-capturing spot is displayed as the streaming image, the user can see a state of image capturing of another user performed at the image-capturing spot, that is, a captured image with another user as the subject, as a reference for image capturing by the self.

Furthermore, in a waiting person number display region R22 on a lower side in the figure of the image display region R21 on the streaming screen, the number “2” indicating the number of persons waiting for image capturing at the image-capturing spot and a ring-shaped gauge indicating a waiting time until image capturing of the user are displayed.

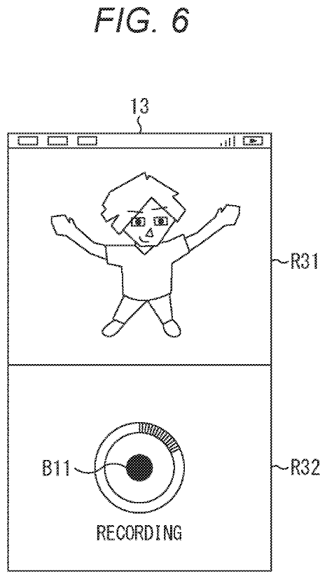

Moreover, when the user's turn of image-capturing comes, the display of the user terminal device 13 transitions from the streaming screen to, for example, an image-capturing screen illustrated in FIG. 6.

In this example, a captured image being currently actually captured by the image-capturing device 11 is displayed in an image display region R31 on an upper side of the image-capturing screen in the figure. Therefore, the user can appropriately perform image capturing while checking the image display region R31.

Furthermore, an image-capturing time display region R32 is provided on a lower side in the figure of the image display region R31 on the image-capturing screen.

In this example, an image-capturing button B11 is provided in the image-capturing time display region R32. When the user presses the image-capturing button B11 to instruct image-capturing start, a captured image is actually captured by the image-capturing device 11 for a certain period of time and stored the captured image in the server 12.

For example, when image capturing is started, a display color of the image-capturing button B11 changes from another color to red, or a text message “RECRDING” indicating that image capturing is being performed is displayed, which allow the user to easily grasp that the captured image is being captured.

Furthermore, in the image-capturing time display region R32, a ring-shaped gauge indicating a remaining time of the image capturing is displayed so as to surround the image-capturing button B11, and the user can easily grasp the remaining time of the image-capturing by viewing the gauge. In addition, the image-capturing button B11 may be used not only as a button for instructing image-capturing start but also as a button for instructing image-capturing end.

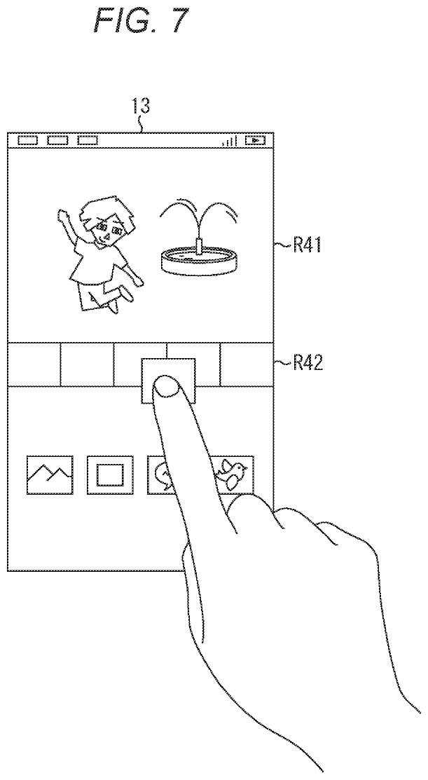

When the image capturing at the image-capturing place (the image-capturing spot) is ended as described above, for example, the user can control to display a selection and save screen for a captured image illustrated in FIG. 7 at any timing, to save (download) a preferred captured image.

In the example illustrated in FIG. 7, an image display region R41 and a list display region R42 are provided on the selection and save screen.

In the list display region R42, thumbnail images of captured images obtained by the user capturing images at one or a plurality of image-capturing places are arranged and displayed.

Here, only one thumbnail image may be displayed for one captured image, or a plurality of thumbnail images may be displayed for one captured image.

Furthermore, when the user selects a thumbnail image displayed in the list display region R42, the entire captured image corresponding to the selected thumbnail image or a time section (a reproduction section) of a part of the captured image corresponding to the thumbnail image is reproduced in the image display region R41.

When the user selects a captured image desired to be saved, a section of a captured image desired to be saved, or the like by performing an operation on the list display region R42 or the like, the captured image is saved in response to the user's operation. That is, the captured image for saving is downloaded from the server 12 by the user terminal device 13.

Note that, here, an example in which the captured image is saved in response to the user's operation is described. However, in addition, the captured image designated by the user may be shared on a page on the web such as a social networking service (SNS).

Furthermore, as described above, the image-capturing place of the captured image may be a dedicated booth in a store such as a restaurant, in addition to an image-capturing spot of outdoors or the like.

For example, in a case where the user selects, from the guide image list V11 illustrated in FIG. 2, a guide image whose subject is food or the like provided at a restaurant that handles the image-capturing service, the user may be allowed to make a reservation for the restaurant in a state where the selected guide image illustrated in FIG. 3 or the map to the image-capturing place is displayed.

In such a case, image capturing of a captured image is reserved simultaneously with the reservation for eating and drinking at the restaurant. When the reservation is completed, the user heads to the restaurant (the image-capturing place) on foot or the like while referring to the map and the like displayed in the map display region R12 of FIG. 3.

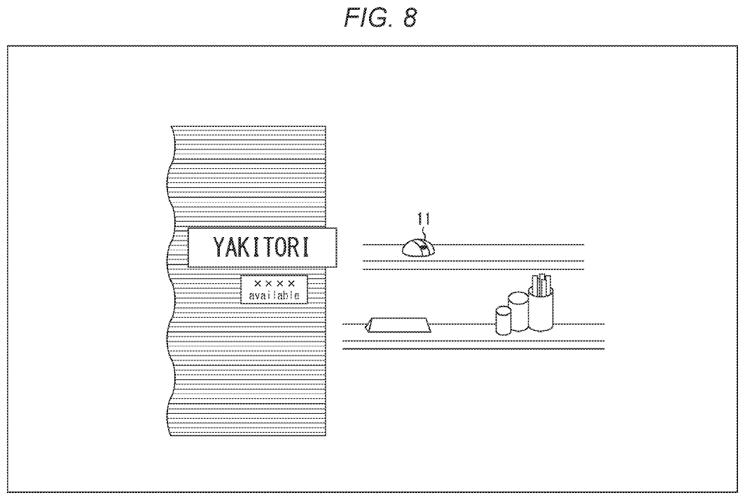

In the restaurant reserved by the user, for example, as illustrated in FIG. 8, a dedicated booth in which the image-capturing device 11 is fixedly installed is prepared, and the user eats and drinks at the dedicated booth.

Here, for example, while the user is eating and drinking, an image is captured by the image-capturing device 11. At this time, since the user does not need to capture an image of food and drink and the like by the self, the user can concentrate on food and drink, conversation with an accompanying person, and the like.

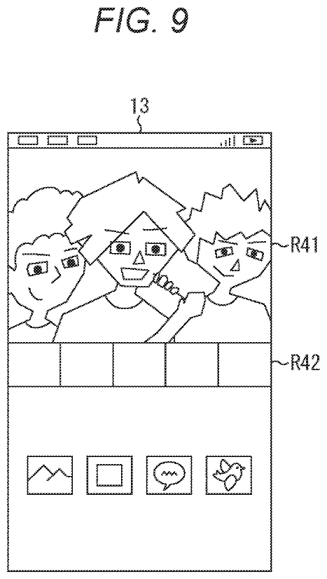

Then, for example, as illustrated in FIG. 9, the user causes the user terminal device 13 to display a selection and save screen similar to that in the case of FIG. 7 at any timing such as during eating or drinking or after eating and drinking, checks captured images that have been captured, and selects a captured image for saving.

Note that, in FIG. 9, portions corresponding to those in the case of FIG. 7 are denoted by the same reference numerals, and the description thereof will be omitted as appropriate.

Also in the example illustrated in FIG. 9, the user performs an operation such as selecting a thumbnail image displayed in a list display region R42 of the selection and save screen, to reproduce a captured image in an image display region R41 or save a captured image corresponding to the selected thumbnail image.

According to the image-capturing service as described above, when the user visits various places such as a tourist spot and a popular restaurant, it is possible to automatically capture and save an image of a situation in which the user enjoys at those places without the user operating a camera or the like. That is, on the user side, it is possible to obtain a captured image at each image-capturing place by automatic image capturing.

Furthermore, after the image capturing, the user can check and download, for personal use, captured images that have been captured and accumulated and correspond to a private picture or a moving image, or the user can allow the captured image to be posted on the SNS.

At this time, for example, in a case where the user determines that the captured image of the self may be published to other people, the captured image of the user can be provided for public use and published to a public browsing site such as a tourist information center or a predetermined site.

Here, the captured image is published in the guide image list, as being for public use.

In particular, in the image-capturing service, an area having a size that allows the user to go around in one day is set as a target area, such as, for example, a sightseeing spot, a mall, or a walk area in a specific area or the like, and a captured image that has been captured at an image-capturing place in the target area is displayed as a guide image in the guide image list.

For example, in the image-capturing service described with reference to FIGS. 2 to 9, the user visits an image-capturing spot, a restaurant, or the like with, as a trigger, a captured image of another user published in the guide image list.

When the user selects, from the guide image list, one or a plurality of guide images captured at an image-capturing place that the self wants to go to, a map for guidance to the image-capturing place corresponding to the selected guide image as illustrated in FIG. 3 is presented in accordance with the selection.

This map indicates, for example, a route from a current location of the user (the user terminal device 13) to one or a plurality of image-capturing places as a destination.

Note that, in a case where a queue has already formed when the destination is a popular store or the like, or in a case where the user is to eat at a restaurant that is one of the destinations, the user terminal device 13 may appropriately use artificial intelligence (AI) or the like to determine time to go to the store, time to eat, an order of going around the destinations, and the like. Furthermore, the user terminal device 13 may use AI or the like to estimate a waiting time at a store, a time required for eating, or the like, to present to the user.

In addition, in the example illustrated in FIG. 3, the case has been described in which the route to the image-capturing place as the destination is presented on the map. However, without limiting to this, it is also possible to display a link, a tag, or the like of a web page or the like on which information regarding the image-capturing spot as the image-capturing place or the restaurant appears.

Furthermore, in operation of the image-capturing system, for example, from a store, a tourist promotion organization, an advertiser, a platformer of the image-capturing service, or the like, an incentive may be given to another user who has provided a guide image (a captured image) that has triggered the user to visit the image-capturing place.

The incentive mentioned here is, for example, various points such as discount points and mile points, coupons, electronic money, and the like.

If the incentive is given to users who use the image-capturing service, each user naturally devises posing at the time of image-capturing or a way of representing a situation of having food and drink with gusto such that the captured image of the self attracts attention of other users.

Therefore, more guide images having good appearance to make other users want to go to the image-capturing place are presented in the guide image list. As a result, target areas such as sightseeing spots, malls, and walk areas are activated, and users can also obtain captured images that give high satisfaction with reference to the guide image, so that the image-capturing system can be continuously operated actively at all times.

(Configuration Example of Server)

Next, configuration examples of the server 12 and the user terminal device 13 constituting the image-capturing system described above will be described.

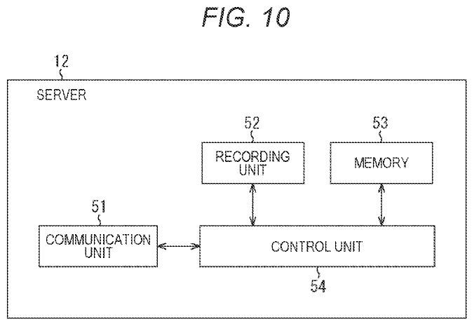

FIG. 10 is a diagram illustrating a configuration example of the server 12.

The server 12 includes a communication unit 51, a recording unit 52, a memory 53, and a control unit 54.

The communication unit 51 communicates with the image-capturing device 11, the user terminal device 13, and the store terminal device 14 via a network. That is, the communication unit 51 receives information transmitted from a communication partner and supplies to the control unit 54, and transmits information supplied from the control unit 54 to the communication partner.

The recording unit 52 includes, for example, a non-volatile memory or the like, records various types of information such as a captured image of each user captured by the image-capturing device 11, a program, and the like, and supplies the recorded information to the control unit 54 as necessary.

The memory 53 is a volatile memory, and temporarily records information supplied from the control unit 54.

The control unit 54 includes a processor or the like, and controls an operation of the entire server 12. For example, the control unit 54 controls image capturing by the image-capturing device 11, and generates a guide image list on the basis of the captured image recorded in the recording unit 52.

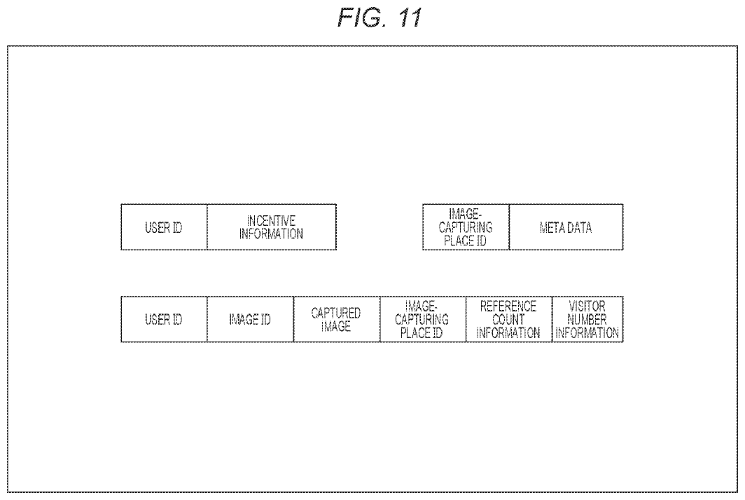

Furthermore, in the recording unit 52 of the server 12, for example, information illustrated in FIG. 11 is recorded.

In the example illustrated in FIG. 11, a user ID for uniquely identifying each user and incentive information indicating an incentive given to the user are recorded in association with each other in the recording unit 52.

Here, the incentive information is information indicating a total of points or electronic money as an incentive given to the user indicated by the user ID, that is, information indicating the number of points, a balance of electronic money, or the like.

Furthermore, in the recording unit 52, an image-capturing place ID for identifying each image-capturing place such as an image-capturing spot or a restaurant and metadata regarding the image-capturing place are recorded in association with each other.

The metadata of the image-capturing place includes a uniform resource locator (URL) of a web page on which information regarding the image-capturing place appears, information indicating a location of the image-capturing place, and information such as an access destination of the store terminal device 14 corresponding to the image-capturing place. Note that the information indicating the location of the image-capturing place may be information indicating a display location on a map, may be information indicating an absolute location such as latitude and longitude on the earth's surface, or may be information indicating both locations.

Moreover, in the recording unit 52, a user ID, an image ID, a captured image, an image-capturing place ID, reference count information, and visitor number information are recorded in association with each other.

Here, the captured image is an image captured at an image-capturing place indicated by the image-capturing place ID when the user indicated by the user ID associated with the captured image uses the image-capturing service. Furthermore, the image ID is ID information for identifying the captured image.

The reference count information is information indicating the number of times the captured image has been selected as a selected guide image by other users in the guide image list, that is, a reference count of being referred to by other users.

Similarly, the visitor number information is information indicating a visitor number in the image-capturing place based on presentation of the captured image (the guide image). More specifically, the visitor number information is information indicating the number (the visitor number) of users who have actually visited the image-capturing place corresponding to a selected guide image after selecting the captured image as the selected guide image, that is, the number of users who have actually performed image capturing at the image-capturing place by being triggered by seeing the captured image.

<Configuration Example of User Terminal Device>

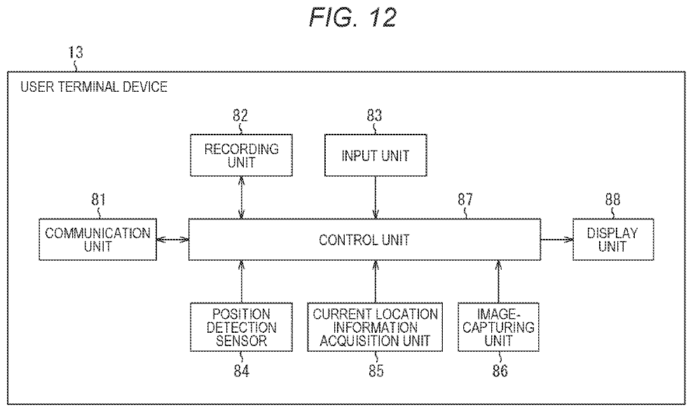

Furthermore, the user terminal device 13 is configured as illustrated in FIG. 12, for example.

In the example illustrated in FIG. 12, the user terminal device 13 includes a communication unit 81, a recording unit 82, an input unit 83, a position detection sensor 84, a current location information acquisition unit 85, an image-capturing unit 86, a control unit 87, and a display unit 88.

The communication unit 81 communicates with the server 12 via a network in accordance with control of the control unit 87. For example, the communication unit 81 receives information transmitted from the server 12 and supplies to the control unit 87, and transmits information supplied from the control unit 87 to the server 12.

The recording unit 82 includes, for example, a non-volatile memory, and records various types of information such as an application program of the image-capturing service and a captured image.

The input unit 83 includes a switch, a button, a touch panel superimposed on the display unit 88, and the like, and supplies a signal corresponding to a user's operation to the control unit 87.

The position detection sensor 84 includes, for example, a gyro sensor or the like, detects a position of the user terminal device 13, and supplies position information obtained as a result to the control unit 87.

The current location information acquisition unit 85 includes, for example, a global positioning system (GPS) module or the like, measures a current location of the user terminal device 13, that is, the user who owns the user terminal device 13, and supplies current location information obtained as a result to the control unit 87.

The image-capturing unit 86 includes a camera, captures an environmental image with surroundings of the user terminal device 13 as a subject, and supplies the obtained environmental image to the control unit 87.

The control unit 87 includes a processor or the like, and controls the entire operation of the user terminal device 13. For example, the control unit 87 executes an application program recorded in the recording unit 82, to perform various types of processing related to the image-capturing service.

Furthermore, the control unit 87 supplies various images to the display unit 88 and controls to display. The display unit 88 includes, for example, a display panel such as organic electro luminescence (EL), and displays various images in accordance with control of the control unit 87.

<Description of Selection Processing and Guide Image List Provision Processing>

Next, operations of the user terminal device 13 and the server 12 will be described.

First, processing performed when the user selects a selected guide image from a guide image list will be described.

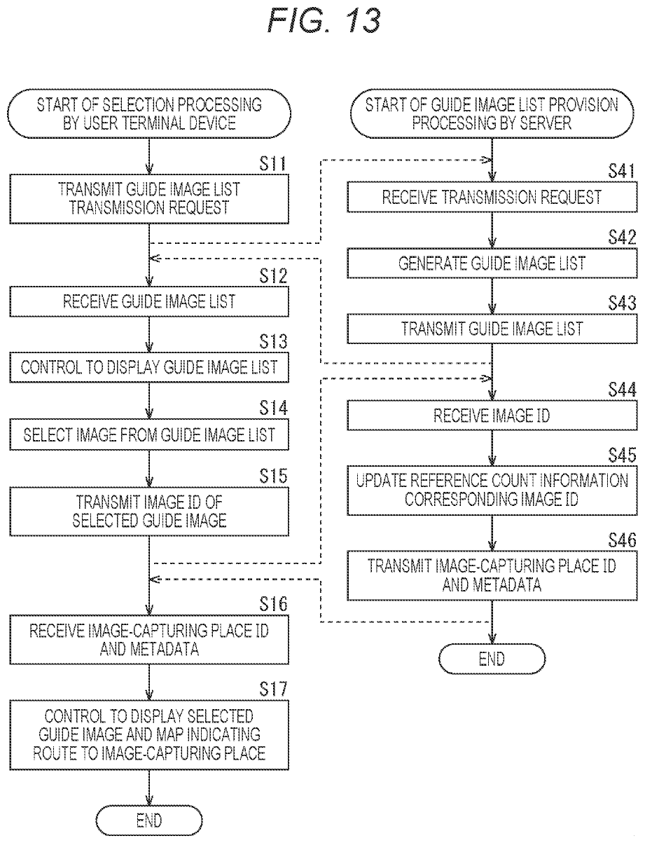

That is, selection processing by the user terminal device 13 and guide image list provision processing by the server 12 will be described below with reference to the flowchart in FIG. 13. In particular, here, a case where a guide image of an image-capturing spot is selected as a selected guide image will be described.

For example, when the user starts an application program of the image-capturing service by operating the input unit 83, or the like, the selection processing by the user terminal device 13 is started.

In step S11, the communication unit 81 of the user terminal device 13 transmits, to the server 12, a guide image list transmission request generated by the control unit 87 and supplied from the control unit 87.

Then, in the server 12, in step S41, the communication unit 51 receives the transmission request transmitted from the user terminal device 13, and supplies to the control unit 54.

In step S42, the control unit 54 generates a guide image list in response to the transmission request supplied from the communication unit 51.

That is, the control unit 54 selects a plurality of guide images from among a plurality of captured images recorded in the recording unit 52.

Then, by arranging the plurality of selected captured images in a predetermined size or order as guide images, the control unit 54 generates a guide image list, more specifically, image information for displaying the guide image list.

Here, for example, the transmission request transmitted in step S11 may include a user ID and current location information of the user who is the owner of the user terminal device 13.

In such a case, as a candidate for the guide image, for example, a captured image is selected in which another user ID other than the user ID included in the transmission request is associated with an image-capturing place ID indicating an image-capturing place in a target area close to a location indicated by the current location information included in the transmission request.

Note that the target area may be selected on the user side, and the control unit 54 may select a candidate for the guide image by targeting an image-capturing place in the target area designated by the user.

The control unit 54 selects some or all of candidates for the guide image selected in this manner as guide images (image-capturing sample images), and generates a guide image list (an image-capturing sample image list) on the basis of the selected guide images.

At this time, on the basis of at least any one of, for example, reference count information or visitor number information associated with each captured image (guide image image), a degree of popularity of an image-capturing place, priority of the image-capturing place determined by a local government or the like, an evaluation value of an appearance of the captured image, the number of persons waiting for image capturing at the image-capturing place, a degree of similarity to an image preferred by the user, a degree of similarity to an image-capturing place where the user has performed image capturing in the past, an estimation value of a degree of preference of the user for the captured image, a season, a time zone, and weather, the control unit 54 selects a guide image and determines a size (a display size) and a display order (a display location) of the guide image in the guide image list.

For example, as the reference count indicated by the reference count information or the visitor number indicated by the visitor number information is larger, the display size is to be larger and the display order is to be earlier.

This is because, it can be said that, as the reference count or the visitor number is larger, evaluation of the appearance from other users is higher, and the guide image is of a more popular image-capturing place.

Note that, in the guide image list, a guide image with an earlier display order is displayed at a higher location, that is, at a location more easily visible to the user.

Furthermore, for example, a guide image having a higher degree of popularity or priority of the image-capturing place is to have a larger display size and an earlier display order.

The degree of popularity of the image-capturing place is determined by the control unit 54 on the basis of, for example, the number of captured images recorded in the recording unit 52. In this case, an image-capturing place having a larger number of recorded captured images can be regarded as a more popular image-capturing place.

On the other hand, the priority of the image-capturing place can be determined in advance by a side (promoter) that attracts the user to a sightseeing spot or the like that is the target area, such as, for example, a tourist information center, a local government having a sightseeing spot, a management association of a sightseeing spot or the like, a store having an image-capturing place, or a sponsor of the image-capturing system. As a result, it is possible to reflect an intention of the side that attracts the user, in the guide image list. In other words, it is possible to control to display a guide image in which an idea (an intention) of the promoting side, that is, the promoter that attracts to the image-capturing place is reflected in the guide image list.

Moreover, for example, an evaluation value of the appearance of the guide image can be calculated on the basis of an analysis result obtained by performing analysis processing regarding a composition, a luminance distribution, hue, an edge amount, and the like, on the guide image.

In this case, a guide image having a higher evaluation value of the appearance, that is, a guide image having a better appearance is to have a larger display size and an earlier display order.

Furthermore, for example, a guide image of an image-capturing place where a current number of persons waiting for image capturing is large, in other words, an image-capturing place where the waiting time until image capturing is long is to have a smaller display size and also a delayed display order, in accordance with the number of persons waiting for image capturing.

Here, the current number of persons waiting for image capturing can be obtained on the basis of, for example, information regarding a reservation of image capturing at each image-capturing place currently recorded in the memory 53.

In addition, a degree of similarity to an image preferred by the user can be, for example, a degree of similarity between the guide image and an image highly evaluated by the user, such as a composition, a luminance distribution, hue, an edge amount, and a subject, and a guide image having a higher degree of similarity is to have a larger display size and an earlier display order.

Here, the image preferred by the user, that is, the image highly evaluated by the user is, for example, an image to which the user gives high evaluation, such as “Like” to an image of another user by using an SNS. For example, in a case where the user uses an SNS provided by the server 12 or another server different from the server 12 by using the user ID of the self, such an image preferred by the user can be specified on the basis of a record or the like of the SNS.

Note that the image preferred by the user is not limited to an image that appears on the web through the SNS, and may be any image as long as the image exists on the web, such as an image that appears on another web page.

Furthermore, for example, a guide image of an image-capturing place having a higher degree of similarity to an image-capturing place where the user has performed image capturing in the past is to have a larger display size and an earlier display order.

For example, what kind of place the image-capturing place is, such as a park or a restaurant, can be specified from the image-capturing place ID. Therefore, a degree of the degree of similarity between the image-capturing place of the guide image and the image-capturing place of the captured image of the user recorded in the recording unit 52 can be obtained from the specification result.

Since the image-capturing place where the user has performed image capturing in the past is an image-capturing place preferred by the user, there is a high possibility that an image-capturing place similar to the image-capturing place is an image-capturing place that the user wants to go to. Therefore, a guide image of such an image-capturing place having a high degree of similarity is to have a larger display size and an earlier display order.

In this way, determining the display size and the display order of the guide image in accordance with a degree of similarity to an image-capturing place where the user has performed image capturing in the past and a degree of similarity to an image preferred by the user can be said to be displaying a guide image reflecting the user's taste in the guide image list.

In addition, as a method of selecting a guide image reflecting the user's taste, it is also possible to use an estimator that uses, as an input, a captured image that is a candidate for the guide image and outputs an estimation value of a degree of preference of the user for the captured image.

Such an estimator can be generated by learning such as deep learning or machine learning, on the basis of, for example, an image posted or browsed by the user, a use history of an SNS by the user such as an image to which high evaluation is given such as “Like”, past action data of the user such as an image-capturing place where the user has performed image capturing in the past, and the like.

For example, the control unit 54 obtains an estimation value of a degree of preference of the user for each captured image, on the basis of each captured image that is a candidate for the guide image and an estimator obtained in advance by learning. Then, the control unit 54 selects a guide image on the basis of the estimation value, and determines a display location and a display order of each guide image.

At this time, in the guide image list, a guide image having a higher estimation value of the degree of preference of the user is to have a larger display size, and an earlier display order.

As described above, selecting the guide image and determining the display size and the display order of the guide image by using the estimator are substantially equivalent to selecting a guide image and determining the display size or the display order of the guide image in accordance with a degree of similarity with an image-capturing place where the user has performed image capturing in the past or a degree of similarity with an image preferred by the user.

Moreover, in selecting a guide image or determining a display size or a display order of the guide image in accordance with a degree of similarity with an image preferred by the user, the image preferred by the user itself, and the user's favorite composition (angle), luminance distribution, hue, and subject, and the like may be learned from the user's captured image in the past, a posted image on an SNS, and the like. In this case, on the basis of a learning result and the captured image, a degree of similarity between each captured image (guide image) and the image preferred by the user is obtained.

Moreover, for example, a guide image captured at a time when the process of step S42 is performed, that is, a guide image captured at a season, a time zone, and weather closer to a current season, time zone, weather is to have a larger display size and an earlier display order.

Note that the season and time when the guide image (the captured image) has been captured can be specified from, for example, an image-capturing date and image-capturing time included in metadata of the guide image. Furthermore, the current weather can be obtained by accessing a server or the like that provides weather information.

For example, the guide image close to that of the current season, time zone, and weather is an image having hue and the like close to that of a captured image obtained when the user performs capturing from now on, and the user can easily imagine what kind of image can be obtained as a captured image of the self, by looking at the guide image.

Therefore, by displaying such a guide image in a larger size at a location that is easier for the user to see, there is a high possibility that the user can obtain a captured image close to that supposed (imagined) by the self, and the user's satisfaction can be improved.

In addition, a recommended image-capturing place according to the current or future season or time zone may be presented together with the guide image list.

In such a case, for example, when the user operates the input unit 83 or the like to select a season or a time zone by designating a desired date and time or the like, information indicating a recommended image-capturing place determined for the selected season or time zone and a guide image of the image-capturing place are displayed on the display unit 88.

Furthermore, in the guide image list, for example, the guide image may be displayed in a display format different for every type of image-capturing place of the guide image, such as a temple, a restaurant, or a park. Specifically, for example, an outer frame of the guide image can be displayed in a color corresponding to the type of the image-capturing place of the guide image.

Moreover, the guide image may be collectively displayed for every type of image-capturing place, by providing a region for every type of image-capturing place in the guide image list, or the like. In addition, the guide image list may be generated in the user terminal device 13.

When having generated the guide image list as described above, the control unit 54 supplies the obtained guide image list to the communication unit 51, and thereafter, the process proceeds to step S43.

Note that, more specifically, in the guide image list, a guide image is associated with an image ID indicating the guide image, and a guide image selected from the guide image list can be specified with the image ID.

In step S43, the communication unit 51 transmits the guide image list supplied from the control unit 54, to the user terminal device 13.

Then, in the user terminal device 13, in step S12, the communication unit 81 receives the guide image list transmitted from the server 12, and supplies to the control unit 87.

In step S13, the control unit 87 supplies the guide image list (the image-capturing sample image list) supplied from the communication unit 81 to the display unit 88, and causes the display unit 88 to display the guide image list. As a result, for example, the guide image list V11 illustrated in FIG. 2 is displayed.

When the guide image list is displayed, the user operates the input unit 83 to select, as the selected guide image, a desired guide image from the guide image list.

In step S14, the control unit 87 selects, as the selected guide image, a guide image selected by the user from the guide image list displayed on the display unit 88, on the basis of a signal supplied from the input unit 83 in response to a selection operation by the user. Then, the control unit 87 supplies the image ID of the selected guide image to the communication unit 81.

In step S15, the communication unit 81 transmits the image ID of the selected guide image supplied from the control unit 87, to the server 12.

Then, in the server 12, in step S44, the communication unit 51 receives the image ID transmitted from the user terminal device 13, and supplies to the control unit 54.

In step S45, the control unit 54 updates reference count information recorded in the recording unit 52 in association with the image ID supplied from the communication unit 51. That is, a reference count indicated by the reference count information is incremented by 1.

Note that, at a time when the selected guide image is selected, not only the reference count information may be updated, but also a predetermined incentive may be given to the user and the incentive information may be updated.

Furthermore, when the reference count information is updated, the control unit 54 reads an image-capturing place ID associated with the image ID received in step S44 from the recording unit 52, also reads metadata recorded in the recording unit 52 in association with the image-capturing place ID, and supplies the image-capturing place ID and the metadata to the communication unit 51. The metadata read in this manner is metadata of the image-capturing place of the selected guide image.

In step S46, the communication unit 51 transmits the image-capturing place ID and the metadata supplied from the control unit 54 to the user terminal device 13, and the guide image list provision processing ends.

As described above, in the server 12, in a case where the selected guide image is selected in the user terminal device 13 that is a transmission destination of the guide image list, metadata necessary for displaying a map for guidance of the user to the image-capturing place of the selected guide image is transmitted to the user terminal device 13.

Furthermore, in the user terminal device 13, in step S16, the communication unit 81 receives the image-capturing place ID and the metadata transmitted from the server 12, and supplies to the control unit 87.

On the basis of the image-capturing place ID and the metadata supplied from the communication unit 81 and the guide image list, the control unit 87 generates image information for displaying the selected guide image and a map indicating a route to the image-capturing place of the selected guide image.

In step S17, the control unit 87 supplies the generated image information to the display unit 88, and controls to display the selected guide image and the map indicating the route to the image-capturing place of the selected guide image. As a result, for example, the display screen illustrated in FIG. 3 is displayed on the display unit 88. Furthermore, in a case where there is voice information for guidance to the image-capturing place as the guide information, the control unit 87 causes a speaker (not illustrated) to output voice on the basis of the voice information, to control to present the voice information to the user.

For example, in the example illustrated in FIG. 3, the map indicating the route from the current location of the user to the image-capturing place of the selected guide image is displayed in the map display region R12.

In this case, the current location of the user can be specified with the current location information supplied from the current location information acquisition unit 85, and a display location of the image-capturing place on the map can be specified from the metadata of the image-capturing place.

Furthermore, for example, in a case where there is another image-capturing place or the like recommended by a local government or the like around the image-capturing place, such as a location between the current location of the user and the image-capturing place, a mark indicating the recommended image-capturing place, an image indicating that it is recommended, and the like may also be displayed on the map of the map display region R12. In such a case, for example, in step S46, it suffices that the image-capturing place ID and the metadata of the recommended image-capturing place are also transmitted.

In addition, the image information for displaying the display screen in step S17 may be generated not on the user terminal device 13 side but on the server 12 side.

Note that, in presenting the route from the current location of the user to the image-capturing place of the selected guide image, the control unit 87 or the control unit 54 may determine an appropriate route on the basis of a waiting time for image capturing at each image-capturing place, a necessary stay time at each image-capturing place, and a current time zone, season, and weather.

For example, in a time zone such as evening in the winter, the user can more enjoy image capturing, sightseeing, walking, and the like by presenting a route heading to the image-capturing place through an illuminated road.

When the process of step S17 is performed and the selected guide image and the map are displayed, the selection processing ends.

As described above, the user terminal device 13 displays a guide image list, selects a selected guide image from the guide image list, and displays a map indicating a route to the image-capturing place, and the like.

Furthermore, the server 12 generates a guide image list and transmits to the user terminal device 13, and also transmits an image-capturing place ID and metadata of the image-capturing place of the selected guide image selected by the user.

By doing this way, the user can select a guide image of an image-capturing place or the like that the user wants to go to from the guide image list, and head to the image-capturing place. That is, it is possible to select an interesting one from guide images actually captured at the image-capturing place, and head to the image-capturing place of the guide image.

Therefore, for example, when the user actually goes to the image-capturing place or looks at a captured image obtained by image capturing, it is possible to prevent the user from feeling that the captured image is different from own imagination, and to obtain the captured image as imagined by the self. That is, a captured image that gives higher satisfaction can be obtained.

<Description of Image-Capturing Start Instruction Processing and Image-Capturing Control Processing>

Furthermore, for example, while the user is walking toward an image-capturing place of a selected guide image in a state where the display screen of FIG. 3 is displayed, the control unit 87 of the user terminal device 13 detects an approach of the user to the image-capturing place on the basis of current location information sequentially supplied from the current location information acquisition unit 85 and metadata of the image-capturing place.

For example, when a distance from the image-capturing place of the selected guide image to the user (the user terminal device 13) becomes a predetermined distance or less, the control unit 87 controls display of a pop-up prompting transition to the AR display state.

That is, the control unit 87 controls the display unit 88 to display a pop-up image prompting transition to the AR display state on the display unit 88.

When the user operates the input unit 83 or holds the user terminal device 13 toward a direction of the image-capturing place in response to this display, transition is made to the AR display state, and image-capturing start instruction processing is started in the user terminal device 13. Furthermore, in response to this processing, the server 12 starts the image-capturing control processing.

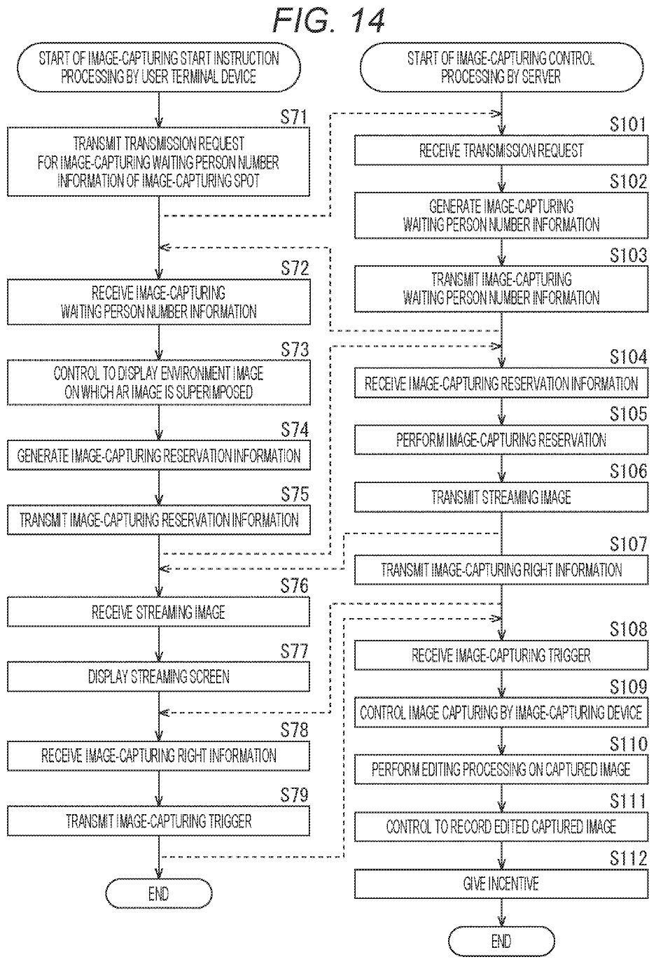

Hereinafter, the image-capturing start instruction processing by the user terminal device 13 and the image-capturing control processing by the server 12 will be described with reference to the flowchart in FIG. 14. Note that, also here, a case where the image-capturing place of the selected guide image is an image-capturing spot will be described.

When the image-capturing start instruction processing is started, in the user terminal device 13, in step S71, the communication unit 81 transmits a transmission request for image-capturing waiting person number information indicating the number of persons waiting for image capturing at the image-capturing place (the image-capturing spot) to the server 12.

For example, the control unit 87 generates a transmission request for requesting transmission of the image-capturing waiting person number information including an image-capturing place ID of an image-capturing place of a selected guide image near the user (the user terminal device 13), and supplies the transmission request to the communication unit 81. Then, the communication unit 81 transmits the transmission request supplied from the control unit 87, to the server 12.

Then, in the server 12, in step S101, the communication unit 51 receives the transmission request transmitted from the user terminal device 13, and supplies to the control unit 54.

In step S102, in response to the transmission request supplied from the communication unit 51, the control unit 54 generates image-capturing waiting person number information indicating a current number of users waiting for image capturing for the image-capturing place indicated by the image-capturing place ID included in the transmission request, and supplies the image-capturing waiting person number information to the communication unit 51.

For example, for each image-capturing place, the control unit 54 causes the memory 53 to record, as image-capturing order information, a result of arranging and associating user IDs of users whose image-capturing has been reserved in an image-capturing order, for the image-capturing place ID of the image-capturing place.

Here, the control unit 54 generates information indicating the number of user IDs included in the image-capturing order information as the image-capturing waiting person number information.

In step S103, the communication unit 51 transmits the image-capturing waiting person number information supplied from the control unit 54, to the user terminal device 13.

Then, in the user terminal device 13, in step S72, the communication unit 81 receives the image-capturing waiting person number information transmitted from the server 12, and supplies to the control unit 87.

The control unit 87 generate an environment image on which an AR image is superimposed, on the basis of the image-capturing waiting person number information supplied from the communication unit 81, metadata of the image-capturing place corresponding to the selected guide image, position information from the position detection sensor 84, current location information from the current location information acquisition unit 85, an environment image from the image-capturing unit 86, and the like.

For example, since a region of the image-capturing place (the image-capturing spot) on the environment image can be specified from the current location information or the position information and on the basis of the metadata of the image-capturing place, the AR image is superimposed on the environment image on the basis of the specification result.

In step S73, the control unit 87 supplies the environment image on which the AR image is superimposed to the display unit 88 and controls to display. As a result, for example, the AR image illustrated in FIG. 4 is superimposed and displayed on the environment image, and the AR display state is established.

By viewing such an AR image, the user can more specifically imagine a captured image obtained when performing image capturing. Moreover, since the user can determine the image-capturing place to finally capture an image while viewing the AR image, the user can efficiently capture an image or efficiently visit a plurality of image-capturing spots.

Furthermore, when the user operates the input unit 83 in the AR display state to designate a desired image-capturing place (image-capturing spot) and instructs a reservation of image capturing at the image-capturing place, a signal corresponding to the user's operation is supplied from the input unit 83 to the control unit 87.

In step S74, the control unit 87 generates image-capturing reservation information indicating that image-capturing at the designated image-capturing place is reserved in accordance with the signal supplied from the input unit 83, and supplies the image-capturing reservation information to the communication unit 81.

The image-capturing reservation information includes, for example, a user ID indicating a user who is a person making the reservation, and an image-capturing place ID indicating an image-capturing place where image capturing is reserved.

In step S75, the communication unit 81 transmits the image-capturing reservation information supplied from the control unit 87, to the server 12.

Then, in the server 12, in step S104, the communication unit 51 receives the image-capturing reservation information transmitted from the user terminal device 13, and supplies to the control unit 54.

In step S105, the control unit 54 performs an image-capturing reservation of the user on the basis of the image-capturing reservation information supplied from the communication unit 51.

Specifically, the control unit 54 updates the image-capturing order information, by adding a user ID included in the image-capturing reservation information to the image-capturing order information including the same image-capturing place ID as that included in the image-capturing reservation information, among the image-capturing order information recorded in the memory 53. As a result, image capturing of the user at the image-capturing place is reserved.

Furthermore, the control unit 54 generates a streaming image for the image-capturing place for which image capturing is reserved in accordance with the image-capturing reservation information, and supplies the streaming image to the communication unit 51.

Here, for example, as the streaming image, a captured image currently being captured at the image-capturing place for which image-capturing has been reserved, a moving image for explaining image capturing at the image-capturing place, or the like is generated. Note that the captured image currently being captured is acquired from the image-capturing device 11 via the communication unit 51.

In step S106, the communication unit 51 transmits the streaming image supplied from the control unit 54 to the user terminal device 13, and thereafter, the process proceeds to step S107.

Furthermore, in the user terminal device 13, in step 576, the communication unit 81 receives the streaming image transmitted from the server 12, and supplies to the control unit 87.

The control unit 87 generates image information for displaying a streaming screen on the basis of the streaming image supplied from the communication unit 81 and on the basis of the image-capturing waiting person number information received in step S72.

In step S77, the control unit 87 supplies the generated image information to the display unit 88, and causes the display unit 88 to display the streaming screen including the streaming image. As a result, for example, the streaming screen illustrated in FIG. 5 is displayed.

Note that, at the time of displaying the streaming screen, the user terminal device 13 communicates with the server 12 as appropriate to acquire the latest image-capturing waiting person number information, and updates display of a gauge indicating the number of persons waiting for image-capturing and a waiting time until image capturing, on the streaming screen.

Whereas, in the server 12, when the streaming image is transmitted in step S106, thereafter, the control unit 54 updates the image-capturing order information recorded in the memory 53 each time image capturing of another user by the image-capturing device 11 ends.

Then, when an image-capturing turn of the user has come, the control unit 54 generates image-capturing right information indicating that the user can perform image capturing, that is, the image-capturing turn of the user has come, and supplies the image-capturing right information to the communication unit 51.

In step S107, the communication unit 51 transmits the image-capturing right information supplied from the control unit 54, to the user terminal device 13.

Note that, in step S107, an image captured by the image-capturing device 11 installed at the image-capturing place where image capturing is performed may be transmitted, as a through image, to the user terminal device 13 together with the image-capturing right information.

Furthermore, in the user terminal device 13, in step S78, the communication unit 81 receives the image-capturing right information transmitted from the server 12, and supplies to the control unit 87.

When the image-capturing right information is supplied from the communication unit 81, the control unit 87 generates image information for displaying an image-capturing screen in accordance with the image-capturing right information.

Furthermore, the control unit 87 supplies the generated image information to the display unit 88, and causes the display unit 88 to display the image-capturing screen. As a result, for example, the image-capturing screen illustrated in FIG. 6 is displayed.

When the image-capturing screen is displayed, for example, the user operates the input unit 83 to instruct image-capturing start, by pressing an image-capturing button on the image-capturing screen, or the like. Then, the control unit 87 generates an image-capturing trigger for instructing image-capturing start in response to a signal supplied from the input unit 83 in response to a user's operation, and supplies the image-capturing trigger to the communication unit 81.

In step S79, the communication unit 81 transmits the image-capturing trigger supplied from the control unit 87 to the server 12, and the image-capturing start instruction processing ends.

Furthermore, in the server 12, in step S108, the communication unit 51 receives the image-capturing trigger transmitted from the user terminal device 13, and supplies to the control unit 54.

In step S109, the control unit 54 controls image capturing by the image-capturing device 11, in response to the image-capturing trigger supplied from the communication unit 51.

That is, the control unit 54 causes the communication unit 51 to transmit, to the image-capturing device 11, a control signal for starting image capturing at the image-capturing place where the user is present, and controls to start image capturing.

Then, since the image-capturing device 11 captures an image of the user as a subject and transmits the obtained captured image to the server 12, the communication unit 51 receives the transmitted captured image, and supplies to the control unit 54.

Note that, here, an example in which image capturing is started with a user's operation as a trigger has been described, but the image capturing may be started when a certain period of time elapses after transmission of the image-capturing right information. In such a case, for example, the time until the image-capturing start can be displayed in a countdown format on the image-capturing screen illustrated in FIG. 6.

In addition, the control unit 54 may perform face recognition or the like on a through image captured by the image-capturing device 11, and image capturing may be started when the face of the user or the face of a person is detected, or when voice of any person or a specific keyword is detected from voice accompanying the through image.

Furthermore, a timing of image-capturing end may be any timing, such as when a certain period of time has elapsed from the image-capturing start or when there is an instruction to end image capturing from the user. Furthermore, when the image capturing of the user is ended, the control unit 54 updates the image-capturing order information recorded in the memory 53.

When the image capturing is ended and the captured image is obtained, thereafter, the process of step S110 is performed.

That is, in step S110, the control unit 54 performs editing processing on the captured image supplied from the image-capturing device 11 via the communication unit 51.

For example, in a case where another person such as a passerby other than the user is included in a captured image, the control unit 54 performs, as the editing processing, processing of blurring a region of the another person in the captured image or processing of removing the another person by replacing a region of the another person with an image of the same region of the captured image at another time.

Furthermore, for example, in a case where the captured image is a moving image, the control unit 54 may perform, as the editing processing, processing of cutting out and deleting a section in which shaking or blurring occurs in the captured image, a section in which the user protrudes outside an angle of view, and the like.

Moreover, for example, as editing processing, the control unit 54 may perform processing of cutting out and connecting only sections that become a highlight scene in a moving image as a captured image, to obtain a final captured image. In this case, for example, a section in which voice in the captured image is at a predetermined level or higher, a section in which a motion of a subject is large, a section in which smile of the user is detected, a section in which a predetermined event is detected, and the like can be cut out as the section of the highlight scene.

In addition, for example, as the editing processing, the control unit 54 may perform processing of cutting out and connecting a plurality of moving images and still images from a moving image as a captured image, to generate, as a final captured image, a moving image in which the moving images and the still images are reproduced as a slide show like an album.

By performing the editing processing as described above, it is possible to obtain a captured image with a better appearance, and to improve the user's satisfaction.

In step S111, the control unit 54 assigns an image ID indicating the captured image to the edited captured image, and supplies, in association with each other, the user ID, the image ID, the edited captured image, the image-capturing place ID, the reference count information, and the visitor number information to the recording unit 52, and controls to record.

In this case, the reference count indicated by the reference count information is set to 0, and the visitor number indicated by the visitor number information is also set to 0.

In step S112, the control unit 54 gives an incentive to a user of the selected guide image that has triggered a user to perform image capturing.

That is, the control unit 54 specifies a user ID associated with the image ID received in step S44 of FIG. 13, and updates incentive information associated with the user ID to give an incentive.

Furthermore, the control unit 54 updates the visitor number information by incrementing, by 1, a visitor number indicated by visitor number information associated with the image ID received in step S44 of FIG. 13.

Note that the incentive may be given, that is, the incentive information may be updated, at a time when an image-capturing reservation is completed, or at a time when a selected guide image is selected.

Furthermore, for example, the incentive is given even in a case where selection has been made as the selected guide image but image capturing has not been performed. In such a case, the incentive to be given may be smaller than that when the image capturing has been performed.

Moreover, the incentive given to the user of the selected guide image may be determined on the basis of a degree of contribution of the user to the image-capturing service, such as the reference count indicated by the reference count information or the visitor number indicated by the visitor number information, which are associated with the selected guide image.

In addition, for example, in a case where the image-capturing place is a store such as a restaurant, the incentive to be given may be determined in accordance with a use result of a service provided at the image-capturing place, such as money amount paid to the store by a user who has visited the store with the selected guide image as a trigger and performed image capturing.

Moreover, for example, the user of the selected guide image may use an SNS, and the selected guide image may be posted (uploaded) on the SNS. In such a case, an incentive to be given may be determined in accordance with, for example, the number of followers of the user or the number of persons who have given high evaluation such as “Like” to the selected guide image posted on the SNS.

As described above, the control unit 54 determines an incentive to be given to the user on the basis of at least any one of, for example, the reference count information, the visitor number information, the use result of the service, the number of followers on the SNS, and the number of users who have made high evaluation on the selected guide image.

In this way, by giving an incentive to a provider of a guide image that serves as a trigger to visit the image-capturing place, it is possible to increase motivation for image capturing of each user, increase the number of users of the image-capturing system, and further activate the target area.

When an incentive is given to the provider (the user) of the selected guide image that has triggered the user to perform image capturing, the image-capturing control processing ends.

As described above, the user terminal device 13 displays and superimposes the AR image indicating the image-capturing place and the number of persons waiting for image capturing on the environment image, and transmits the image-capturing reservation information and the image-capturing trigger to the server 12. Furthermore, the server 12 reserves image capturing in accordance with the image-capturing reservation information, and performs image-capturing control in response to the image-capturing trigger.

By doing so, for example, by viewing the environment image on which the AR image is superimposed, the user can select an image-capturing place where the user actually wants to perform image capturing, and can perform image capturing. As a result, it is possible to obtain a captured image that gives high satisfaction.

Furthermore, in such an image-capturing system, the user does not need to perform an operation such as determining a composition at the time of image capturing or setting image capturing by the self, and can concentrate on and enjoy posing at the time of image capturing, sightseeing, eating and drinking, and the like.

Moreover, since image capturing by the plurality of users is controlled on the server 12 side, not only congestion can be alleviated by efficiently performing the image capturing, but also it is possible to suppress image capturing of each user from disturbing a passage or the like of other users.

<Description of Captured Image Acquisition Processing and Captured Image Provision Processing>

Meanwhile, when the user performs image capturing at one or a plurality of image-capturing places, thereafter, the user can download a captured image that has been captured, at any timing from the server 12 to the user terminal device 13. A download timing of the captured image may be, for example, immediately after image capturing, or may be any timing such as when the user finishes walking in the target area.

In a case of downloading the captured image, the user causes the user terminal device 13 to display a selection and save screen of captured images.

In this case, in response to a request from the user (the user terminal device 13), the control unit 54 of the server 12 generates image information of the selection and save screen on the basis of captured images associated with the user ID indicating the user, and transmits the image information to the user terminal device 13 by the communication unit 51.

Then, in the user terminal device 13, the communication unit 81 receives the image information of the selection and save screen transmitted from the server 12, and supplies to the control unit 87.

Furthermore, the control unit 87 supplies the image information supplied from the communication unit 81 to the display unit 88, and causes the display unit 88 to display the selection and save screen. As a result, for example, the selection and save screen illustrated in FIG. 7 is displayed.

When the selection and save screen is displayed in this manner, the user terminal device 13 performs captured image acquisition processing of downloading a captured image, and the server 12 performs captured image provision processing in response to a request from the user terminal device 13.

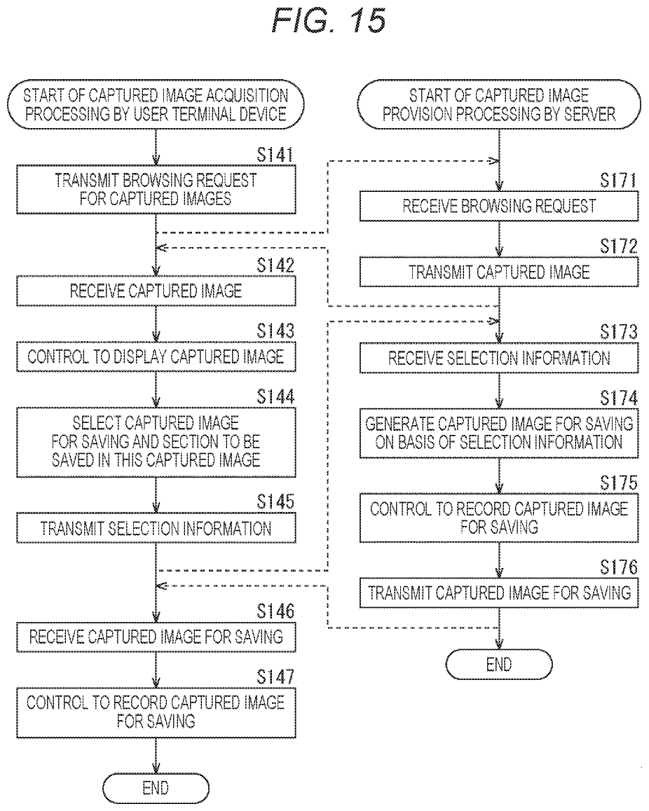

The captured image acquisition processing performed by the user terminal device 13 and the captured image provision processing performed by the server 12 will be described below with reference to the flowchart in FIG. 15.

In step S141, the communication unit 81 of the user terminal device 13 transmits a browsing request for the captured images, to the server 12.

For example, thumbnail images of the captured images of the user are displayed as a list on the selection and save screen displayed on the display unit 88. By designating any thumbnail image, a section of the captured image corresponding to the thumbnail image can be browsed.

Furthermore, more specifically, on the selection and save screen, each thumbnail image is associated with an image ID of a captured image corresponding to the thumbnail image and information indicating a section of the captured image corresponding to the thumbnail image.

In order to select a captured image to be downloaded, the user operates the input unit 83 to select a thumbnail image of a captured image that the user intends to browse (reproduce).

In response to a signal supplied from the input unit 83, the control unit 87 generates a browsing request including the image ID corresponding to the thumbnail image and the information indicating the section, and supplies the browsing request to the communication unit 81. The communication unit 81 transmits the browsing request supplied from the control unit 87, to the server 12.

Then, in the server 12, in step S171, the communication unit 51 receives the browsing request transmitted from the user terminal device 13, and supplies to the control unit 54.

In response to the browsing request supplied from the communication unit 51, the control unit 54 reads the captured image requested to be transmitted from the recording unit 52, cuts out a section indicated by the browsing request in the captured image as necessary, and supplies to the communication unit 51.

In step S172, the communication unit 51 transmits the captured image supplied from the control unit 54, to the user terminal device 13. In this case, the captured image is subjected to streaming distribution to the user terminal device 13.

Furthermore, in the user terminal device 13, in step S142, the communication unit 81 receives the captured image transmitted from the server 12, and supplies to the control unit 87.

In step S143, the control unit 87 supplies the captured image supplied from the communication unit 81 to the display unit 88, and controls to display the captured image.

As a result, for example, in the image display region R41 of the selection and save screen illustrated in FIG. 7, the captured image received in step S142 is reproduced in a streaming format.

The user selects the captured image to be downloaded, that is, to be saved, by operating the input unit 83 while appropriately reproducing and checking the captured image corresponding to the thumbnail image. At this time, it is also possible to select only a partial section of the captured image as the captured image for saving.

Note that editing processing on the captured image may be performed on the user terminal device 13 side. In such a case, for example, the control unit 87 performs editing processing similar to the case in step S110 in FIG. 14.

Moreover, the control unit 87 may also perform editing processing such as trimming or color tone correction on the captured image in response to a user's operation.

When an operation for selecting a captured image for saving is performed, in step S144, the control unit 87 selects a captured image for saving and a section to be saved in the captured image in response to a signal supplied from the input unit 83, and generates selection information indicating a selection result. Furthermore, the control unit 87 supplies the generated selection information to the communication unit 81.

For example, the selection information includes an image ID of the captured image for saving selected by the user and information indicating the section to be saved in the captured image. Note that the user can select a plurality of captured images at a time, or can select a plurality of sections of a captured image.

In step S145, the communication unit 81 transmits the selection information supplied from the control unit 87, to the server 12.

Then, in the server 12, in step S173, the communication unit 51 receives the selection information transmitted from the user terminal device 13, and supplies to the control unit 54.

In step S174, the control unit 54 generates a captured image for saving on the basis of the selection information supplied from the communication unit 51 and on the basis of the edited captured image recorded in the recording unit 52.

Here, for example, the captured image indicated by the selection information is selected from among the edited captured images recorded in step S111 of FIG. 14, and the section indicated by the selection information is cut out from the selected captured image as necessary to obtain the captured image for saving.

In step S175, the control unit 54 supplies the generated captured image for saving to the recording unit 52, and controls to record. Here, the captured image for saving generated in step S174 replaces the edited captured image recorded in step S111 of FIG. 14, and is recorded. Furthermore, the control unit 54 supplies the generated captured image for saving to the communication unit 51.

In step S176, the communication unit 51 transmits the captured image for saving supplied from the control unit 54 to the user terminal device 13, and the captured image provision processing ends.

Furthermore, in the user terminal device 13, in step S146, the communication unit 81 receives the captured image for saving transmitted from the server 12, and supplies to the control unit 87.

In step S147, the control unit 87 supplies the captured image for saving supplied from the communication unit 81 to the recording unit 82 and controls to record, and the captured image acquisition processing ends. As a result, the captured image for saving is considered to be downloaded.

As described above, the user terminal device 13 downloads the captured image for saving from the server 12, by selecting the captured image for saving and transmitting the selection information. Furthermore, the server 12 transmits the captured image selected by the user terminal device 13.

By doing this way, the user can download for saving and save an image preferred by the self from among the captured images that have been captured and accumulated.

Note that, the example of downloading a captured image has been described here, but uploading (posting) of the captured image for saving on an SNS page of the user may be made possible.

Specifically, for example, the control unit 54 of the server 12 may upload the captured image for saving to a page of the user on an SNS managed by the server 12, or may transmit the captured image for saving to another server by the communication unit 51 to upload the captured image for saving to a page of the user on an SNS managed by the another server.

Furthermore, instead of the server 12, the communication unit 81 of the user terminal device 13 may transmit the captured image for saving to the server 12 or another server, to upload the captured image for saving to a page of the user on the SNS.

In this way, when browsing of the captured image for saving on the SNS is enabled, for example, another user who has viewed the page on the SNS may also receive the same service as a case of selecting a desired guide image from the guide image list, by designating the captured image posted on the page.

In such a case, for example, the control unit 87 of the user terminal device 13 and the control unit 54 of the server 12 control transmission of a captured image and the like, a request for posting the captured image, and the like such that the captured image and necessary information such as an image ID of the captured image and a URL for displaying a map of the map display region R12 illustrated in FIG. 3 are associated with each other and posted on the page of the user on the SNS.

As a result, for example, when another user (viewer) who is browsing a page of the user on the SNS designates a captured image posted on the page, the user terminal device 13 of the viewer can access the server 12 on the basis of the image ID, the URL, and the like.

Then, between the user terminal device 13 of the viewer (another user) and the server 12, for example, processes similar to the processes of steps S15 to S17 and the processes of steps S44 to S46 of the selection processing described with reference to FIG. 13 are performed.

As a result, for example, a state is established in which the display screen illustrated in FIG. 3 is displayed on the user terminal device 13 of the viewer, and thereafter, the processing described with reference to FIGS. 14 and 15 is performed, and the viewer can also perform image capturing at the image-capturing place.

In this way, the viewer of the SNS can also be guided to use the image-capturing service, and the target area can be further activated.

<Description of Selection Processing and Guide Image List Provision Processing>

Furthermore, although the case where the image-capturing place is an image-capturing spot of outdoors and the like has been described above, a captured image that gives high satisfaction can be provided to a user even in a case where the image-capturing place is a store such as a restaurant. In this case, the captured image may be an image of only food and drink provided to the user, in addition to an image in which the user is included as a subject.

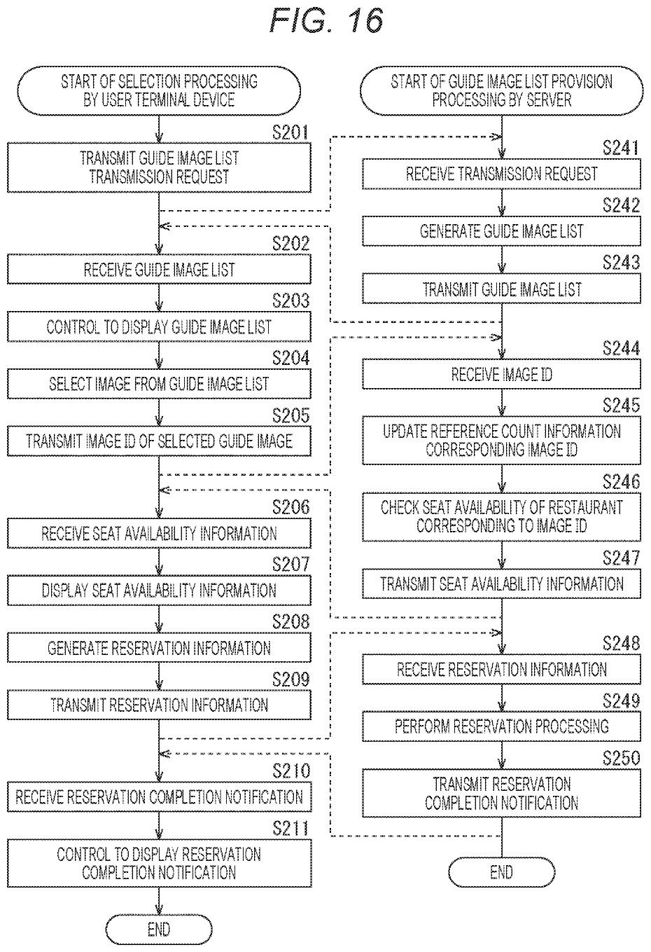

Hereinafter, a case where the image-capturing place is a restaurant will be described as an example. In such a case, for example, in the user terminal device 13 and the server 12, the processing illustrated in FIG. 16 is performed.

Hereinafter, selection processing by the user terminal device 13 and guide image list provision processing by the server 12 will be described with reference to the flowchart in FIG. 16.

Note that the processes in steps S201 to S205 and steps S241 to S245 are similar to the processes in steps S11 to S15 and steps S41 to S45 in FIG. 13, and thus the description thereof will be omitted.

However, for example, in step S203, guide images of various categories, such as a guide image of an image-capturing spot or a store such as a restaurant, may be displayed as a list in a guide image list. Alternatively, the guide images may be displayed as a list for each category, for example, only guide images of restaurants of a predetermined genre are displayed as a list.

Furthermore, in step S204, a guide image with a restaurant as an image-capturing place is selected as a selected guide image.

In step S246, the control unit 54 checks seat availability of a restaurant corresponding to an image ID received in step S244.

That is, the control unit 54 specifies an image-capturing place ID recorded in the recording unit 52 in association with the image ID received in step S244, and reads metadata associated with the image-capturing place ID from the recording unit 52.

Then, the control unit 54 causes the communication unit 51 to communicate with the store terminal device 14 on the basis of an access destination of the store terminal device 14 of a restaurant included in the read metadata, and inquires about seat availability of the restaurant.

The control unit 54 generates seat availability information including: seat availability of the restaurant obtained in this manner; the image-capturing place ID indicating the restaurant; the metadata of the restaurant (the image-capturing place); and a coupon of the restaurant, and supplies the seat availability information to the communication unit 51.

Note that the coupon of the restaurant is not necessarily included in the seat availability information, and the coupon of the restaurant can be issued to the user at any timing such as being issued in advance.

Moreover, the coupon may be issued only to a user satisfying a predetermined condition, such as a user of a specific gender, for example, such as limiting to women, a user who highly frequently uses the image-capturing service, a user who does not use the image-capturing service for a certain period of time, or a user whose reference count indicated by reference count information or visitor number indicated by visitor number information is equal to or more than a predetermined value. Furthermore, the coupon may be issued only at a store such as a specific restaurant.

In step S247, the communication unit 51 transmits the seat availability information supplied from the control unit 54, to the user terminal device 13.

Then, in the user terminal device 13, in step S206, the communication unit 81 receives the seat availability information transmitted from the server 12, and supplies to the control unit 87.

In step S207, the control unit 87 supplies the seat availability information supplied from the communication unit 81 to the display unit 88 and controls to display.

As a result, for example, seat availability at the restaurant, an issued coupon, a URL of a web page of the restaurant, a map indicating a route from the current location of the user terminal device 13 to the restaurant, and the like are displayed on the display unit 88.

The user checks the seat availability and the like displayed on the display unit 88, operates the input unit 83, and appropriately inputs necessary information such as a reservation time, the number of persons to visit, and whether or not the coupon is to be used, to instruct a reservation of the restaurant.

Note that, for example, in a case where the image-capturing place is far away, not only the reservation of the restaurant as the image-capturing place but also a reservation of transportation for movement such as a bus, a train, or an airplane to the image-capturing place, a reservation of an accommodation facility near the image-capturing place, and the like may be made. In such a case, in step S207, information regarding transportations and accommodation facilities, and the like are also displayed.

In step S208, on the basis of a signal supplied from the input unit 83 in response to a user's operation, the control unit 87 generates reservation information including, for example, the user ID, the image-capturing place ID of the restaurant, the reservation time, the number of persons to visit, whether or not a coupon is to be used, and the like, and supplies the reservation information to the communication unit 81.

In step S209, the communication unit 81 requests the reservation of the restaurant by transmitting the reservation information supplied from the control unit 87, to the server 12.

Note that, here, a case where the server 12 makes a reservation for a restaurant is described as an example, but the user terminal device 13 may make the reservation for the restaurant by directly accessing the store terminal device 14 on the basis of the seat availability information, or the like.

In addition, even if the user or the like does not make a reservation for a restaurant, when the user starts to eat or drink at a booth dedicated to an image-capturing service in the restaurant, image capturing may be performed by the user transmitting some sort of image-capturing trigger from the user terminal device 13 to the server 12.

When the reservation information is transmitted from the user terminal device 13 to the server 12, the server 12 performs the process of step S248.

In step S248, the communication unit 51 receives the reservation information transmitted from the user terminal device 13, and supplies to the control unit 54.

In step S249, the control unit 54 performs reservation processing of reserving the restaurant on the basis of the reservation information supplied from the communication unit 51.

For example, by controlling the communication unit 51 to communicate with the store terminal device 14 and transmitting reservation information to the store terminal device 14, and the like, the control unit 54 makes a reservation so that the user can eat and drink at the restaurant at a desired time.

When the reservation is completed, the control unit 54 generates a reservation completion notification indicating that the reservation is completed, including information such as a reservation time, and supplies to the communication unit 51.

In step S250, the communication unit 51 transmits the reservation completion notification supplied from the control unit 54 to the user terminal device 13, and the guide image list provision processing ends.

Furthermore, in the user terminal device 13, in step S210, the communication unit 81 receives the reservation completion notification transmitted from the server 12, and supplies to the control unit 87.

In step S211, the control unit 87 supplies the reservation completion notification supplied from the communication unit 81 to the display unit 88 and controls to display.

As a result, the display unit 88 displays, for example, a message indicating that the restaurant has been reserved, a map indicating a route from the current location to the restaurant that is the image-capturing place, and the like.

When the reservation completion notification is displayed, the selection processing ends.

As described above, the user terminal device 13 displays a guide image list, selects a selected guide image from the guide image list, and displays a map indicating a route to a restaurant, and the like, when a restaurant corresponding to the selected guide image is reserved.

Furthermore, the server 12 generates and transmits a guide image list to the user terminal device 13, and also checks seat availability of a restaurant corresponding to an image-capturing place of the selected guide image selected by the user, and makes a reservation of the restaurant.

In this way, similarly to the case described with reference to the flowchart of FIG. 13, the user can obtain a captured image that gives higher satisfaction.

<Description of Image-Capturing Start Instruction Processing and Image-Capturing Control Processing>

Furthermore, when the process of step S211 of FIG. 16 is performed and a map indicating a route to the reserved restaurant is displayed on the display unit 88, the user heads to the restaurant while viewing the map.

Then, when the user is guided to a booth dedicated to the image-capturing service in the restaurant at the reserved time, the user starts to eat and drink as it is.

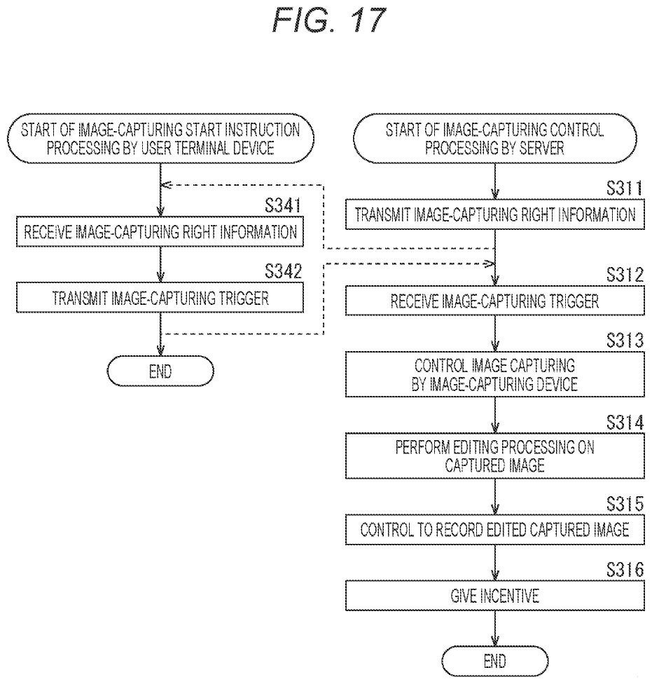

Furthermore, on the basis of the reservation information and the reservation completion notification, the server 12 performs the processing illustrated in FIG. 17 as image-capturing control processing for controlling image capturing in the restaurant where the user is present, at the time for which the user makes the reservation, that is, the time when the user starts eating and drinking.

Hereinafter, the image-capturing control processing performed by the server 12 and image-capturing start instruction processing performed by the user terminal device 13 will be described with reference to the flowchart in FIG. 17.

When the image-capturing control processing is started in the server 12, in step S311, the communication unit 51 transmits image-capturing right information to the user terminal device 13.

That is, at the reservation time of the user, the control unit 54 generates image-capturing right information indicating that image capturing is enabled, and supplies to the communication unit 51. Then, the communication unit 51 transmits the image-capturing right information supplied from the control unit 54, to the user terminal device 13.

Then, in the user terminal device 13, in step S341, the communication unit 81 receives the image-capturing right information transmitted from the server 12, and supplies to the control unit 87.

When the image-capturing right information is supplied from the communication unit 81, the control unit 87 generates image information for displaying a message indicating that an image-capturing start time has come, in accordance with the image-capturing right information. Furthermore, the control unit 87 supplies the generated image information to the display unit 88, and causes the display unit 88 to display the message indicating that the image-capturing start time has come.

When such a message is displayed, for example, the user operates the input unit 83 to instruct image-capturing start. Then, the control unit 87 generates an image-capturing trigger for instructing image-capturing start in response to a signal supplied from the input unit 83 in response to a user's operation, and supplies the image-capturing trigger to the communication unit 81.

In step S342, the communication unit 81 transmits the image-capturing trigger supplied from the control unit 87 to the server 12, and the image-capturing start instruction processing ends.

When the image-capturing trigger is transmitted in this manner, the server 12 performs the processes of steps S312 to S316 and ends the image-capturing control processing. However, since these processes are similar to the processes of steps S108 to S112 of FIG. 14, the description thereof will be omitted.

As described above, when the time for the user to start eating and drinking comes, the server 12 generates and transmits the image-capturing right information to the user terminal device 13, and performs control to start image capturing when the image-capturing trigger is received in response to the transmission. Furthermore, the user terminal device 13 receives the image-capturing right information from the server 12, and transmits the image-capturing trigger to the server 12 in response to a user's operation.

In this way, the user can enjoy eating and drinking and conversation with an accompanying person without being particularly conscious of image capturing, and the satisfaction of the user can be improved.

Note that, here, an example in which image capturing is started with a user's operation as a trigger has been described, but the image capturing may be started when a certain period of time elapses after transmission of the image-capturing right information, or the image capturing may be started when the reservation time for eating and drinking at the restaurant comes.

In addition, the control unit 54 may perform face recognition or the like on a through image captured by the image-capturing device 11, and image capturing may be started when the face of the user or the face of a person is detected, or when voice of any person or a specific keyword is detected from voice accompanying the through image.

Moreover, during image capturing, the server 12 may sequentially perform streaming distribution of a captured image captured by the image-capturing device 11 to the user terminal device 13, and the captured image may be reproduced by the user terminal device 13. In this case, the user can check what kind of image capturing is performed even while eating and drinking.

Furthermore, an image-capturing end timing may be any timing such as a timing at which the user finishes eating and drinking or a timing at which the user gives an instruction for image capturing end.

As described above, even in a case where the image capturing is performed while the user eats and drinks at a restaurant, the user can download the captured image at any timing such as after the image capturing.

In such a case, the user terminal device 13 and the server 12 perform the captured image acquisition processing and the captured image provision processing described with reference to FIG. 15.

Note that, in the above description, an example has been described in which the present technology is applied to a case of performing a walk, sightseeing, eating and drinking, or the like. However, without limiting to this, the present technology can be applied to any system as long as a guide image is presented to a user and the user performs image capturing at an image-capturing place of the guide image.

For example, in the present technology, it is also possible to set public transportation such as a train, a bus, or a ship as an image-capturing place, and make a reservation for the public transportation. Furthermore, the present technology can also be applied to image capturing in sports watching, driving, a reservation and use of a hair salon, shopping, a wedding hall, and the like.

<Configuration Example of Computer>

Meanwhile, the series of processes described above can be executed by hardware or also executed by software. In a case where the series of processes are performed by software, a program that configures the software is installed in a computer. Here, examples of the computer include, for example, a computer that is built in dedicated hardware, a general-purpose personal computer that can perform various functions by being installed with various programs, and the like.

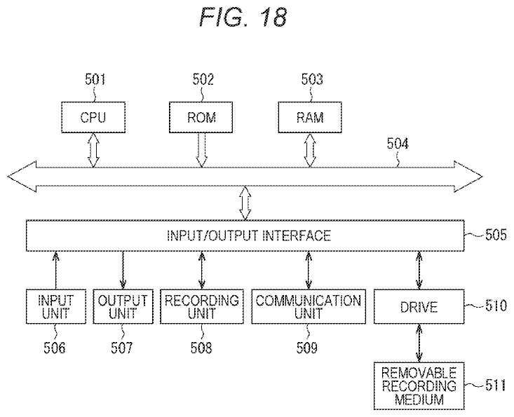

FIG. 18 is a block diagram illustrating a configuration example of hardware of a computer that executes the series of processes described above in accordance with a program.

In the computer, a central processing unit (CPU) 501, a read only memory (ROM) 502, and a random access memory (RAM) 503 are mutually connected by a bus 504.

The bus 504 is further connected with an input/output interface 505. To the input/output interface 505, an input unit 506, an output unit 507, a recording unit 508, a communication unit 509, and a drive 510 are connected.

The input unit 506 includes a keyboard, a mouse, a microphone, an imaging element, and the like. The output unit 507 includes a display, a speaker, and the like. The recording unit 508 includes a hard disk, a non-volatile memory, and the like. The communication unit 509 includes a network interface or the like. The drive 510 drives a removable recording medium 511 such as a magnetic disk, an optical disk, a magneto-optical disk, or a semiconductor memory.

In the computer configured as described above, the series of processes described above are performed, for example, by the CPU 501 loading the program recorded in the recording unit 508 into the RAM 503 via the input/output interface 505 and the bus 504, and executing.

The program executed by the computer (the CPU 501) can be provided by being recorded on, for example, the removable recording medium 511 as a package medium or the like. Furthermore, the program can be provided via a wired or wireless transmission medium such as a local area network, the Internet, or digital satellite broadcasting.

In the computer, by attaching the removable recording medium 511 to the drive 510, the program can be installed in the recording unit 508 via the input/output interface 505. Furthermore, the program can be received by the communication unit 509 via a wired or wireless transmission medium, and installed in the recording unit 508. Besides, the program can be installed in advance in the ROM 502 and the recording unit 508.

Note that the program executed by the computer may be a program that performs processing in a time series according to an order described in this specification, or may be a program that performs processing in parallel or at necessary timing such as when a call is made.

Furthermore, the embodiments of the present technology are not limited to the above-described embodiments, and various modifications can be made without departing from the scope of the present technology.

For example, the present technology can have a cloud computing configuration in which one function is shared and processed in cooperation by a plurality of devices via a network.

Furthermore, each step described in the above-described flowchart can be executed by one device, and also shared and executed by a plurality of devices.

Moreover, in a case where one step includes a plurality of processes, the plurality of processes included in the one step can be executed by one device, and also shared and executed by a plurality of devices.

Moreover, the present technology can also be configured as follows.

(1)

An information processing apparatus including:
a control unit configured to control to display an image-capturing sample image list in which a plurality of image-capturing sample images captured at a plurality of image-capturing places different from each other is arranged, the control unit being configured to control to present guide information for guidance to an image-capturing place among the image-capturing places, the image-capturing place being of a selected image-capturing sample image among the image-capturing sample images in a case where any of the image-capturing sample images is selected from the image-capturing sample image list.

(2)

The information processing apparatus according to (1), in which
each of the image-capturing sample images is an image selected on the basis of at least any one of: an estimation value of a degree of preference of a user for the each of the image-capturing sample images; or a priority of each of the image-capturing places determined by a promoter.

(3)

The information processing apparatus according to (2), in which
a display location or a display size of each of the image-capturing sample images in the image-capturing sample image list is determined by at least any one of the estimation value or the priority.

(4)

The information processing apparatus according to any one of (1) to (3), further including:
a communication unit configured to transmit image-capturing reservation information for a reservation of image capturing at the image-capturing place of the selected image-capturing sample image among the image-capturing sample images.

(5)

The information processing apparatus according to (4), in which
in a case where image capturing of a user at each of the image-capturing places is reserved, the control unit controls to display an image of another user captured at the each of the image-capturing places before image capturing of the user.

(6)

The information processing apparatus according to any one of (1) to (5), further including:
an image-capturing unit configured to capture an environmental image including each of the image-capturing places as a subject, in which
the control unit controls to display the environment image on which an image indicating a location of the each of the image-capturing places is superimposed.

(7)

The information processing apparatus according to any one of (1) to (6), in which
the guide information is a map indicating a route from a current location of the information processing apparatus to each of the image-capturing places.

(8)

An information processing method performed by an information processing apparatus, the information processing method including:
controlling to display an image-capturing sample image list in which a plurality of image-capturing sample images captured at a plurality of image-capturing places different from each other is arranged, and controlling to present guide information for guidance to an image-capturing place among the image-capturing places, the image-capturing place being of a selected image-capturing sample image among the image-capturing sample images in a case where any of the image-capturing sample images is selected from the image-capturing sample image list.

(9)

A program for causing a computer to execute processing including a step of:
controlling to display an image-capturing sample image list in which a plurality of image-capturing sample images captured at a plurality of image-capturing places different from each other is arranged, and controlling to present guide information for guidance to an image-capturing place among the image-capturing places, the image-capturing place being of a selected image-capturing sample image among the image-capturing sample images in a case where any of the image-capturing sample images is selected from the image-capturing sample image list.

(10)

An information processing apparatus including:
a control unit configured to generate an image-capturing sample image list in which a plurality of image-capturing sample images is arranged on the basis of a plurality of the image-capturing sample images captured at a plurality of image-capturing places different from each other; and
a communication unit configured to transmit, to a terminal device, data for guidance to an image-capturing place among the image-capturing places, the image-capturing place being of a selected image-capturing sample image among the image-capturing sample images in a case where any of the image-capturing sample images is selected from the image-capturing sample image list, in the terminal device that is a transmission destination of the image-capturing sample image list.

(11)

The information processing apparatus according to (10), in which
the control unit selects an image-capturing sample image among the image-capturing sample images on the basis of at least any one of: an estimation value of a degree of preference of a user for each of the image-capturing sample images; or a priority of each of the image-capturing places determined by a promoter, and the control unit generates the image-capturing sample image list on the basis of the selected image-capturing sample image among the image-capturing sample images.

(12)

The information processing apparatus according to (11), in which
the control unit determines a display location or a display size of each of the image-capturing sample images in the image-capturing sample image list, on the basis of at least any one of a reference count of each of the image-capturing sample images, a visitor number in each of the image-capturing places based on presentation of each of the image-capturing sample images, a degree of popularity of each of the image-capturing places of each of the image-capturing sample images, the priority, an evaluation value of appearance of each of the image-capturing sample images, a number of persons waiting for image capturing of each of the image-capturing sample images at each of the image-capturing places, a season or a time zone in which each of the image-capturing sample images has been captured, weather at a time of image capturing of each of the image-capturing sample images, a degree of similarity of each of the image-capturing sample images to a predetermined image, or the estimation value.

(13)

The information processing apparatus according to any one of (10) to (12), in which
the control unit controls image capturing by an image-capturing device installed at each of the image-capturing places.

(14)

The information processing apparatus according to (13), in which
the control unit generates the image-capturing sample image list by using a captured image captured by the image-capturing device as each of the image-capturing sample images.

(15)

The information processing apparatus according to (14), in which
the control unit gives an incentive to a user corresponding to the selected image-capturing sample image among the image-capturing sample images.

(16)

The information processing apparatus according to (15), in which
the control unit determines the incentive to be given to the user, on the basis of at least any one of a reference count of each of the image-capturing sample images, a visitor number in each of the image-capturing places based on presentation of each of the image-capturing sample images, or a use result of a service at each of the image-capturing places of another user who has visited the each of the image-capturing places in accordance with presentation of each of the image-capturing sample images.

(17)

The information processing apparatus according to any one of (13) to (16), in which
the communication unit receives image-capturing reservation information transmitted from the terminal device, the image-capturing reservation information being for a reservation of image capturing at the image-capturing place of the selected image-capturing sample image among the image-capturing sample images, and
the control unit makes a reservation for image-capturing on the basis of the image-capturing reservation information.

(18)

The information processing apparatus according to (17), in which
the communication unit transmits, to the terminal device, a captured image captured by the image-capturing device in accordance with the reservation of image capturing.

(19)

An information processing method performed by an information processing apparatus, the information processing method including:
generating an image-capturing sample image list in which a plurality of image-capturing sample images is arranged on the basis of a plurality of the image-capturing sample images captured at a plurality of image-capturing places different from each other; and
transmitting, to a terminal device, data for guidance to an image-capturing place among the image-capturing places, the image-capturing place being of a selected image-capturing sample image among the image-capturing sample images in a case where any of the image-capturing sample images is selected from the image-capturing sample image list, in the terminal device that is a transmission destination of the image-capturing sample image list.

(20)

A program for causing a computer to execute processing including steps of:
generating an image-capturing sample image list in which a plurality of image-capturing sample images is arranged on the basis of a plurality of the image-capturing sample images captured at a plurality of image-capturing places different from each other; and
transmitting, to a terminal device, data for guidance to an image-capturing place among the image-capturing places, the image-capturing place being of a selected image-capturing sample image among the image-capturing sample images in a case where any of the image-capturing sample images is selected from the image-capturing sample image list, in the terminal device that is a transmission destination of the image-capturing sample image list.

### REFERENCE SIGNS LIST

11-1 to 11-N, 11 Image-capturing device
12 Server
13 User terminal device
14 Store terminal device
51 Communication unit
52 Recording unit
54 Control unit
81 Communication unit
82 Recording unit
83 Input unit
86 Image-capturing unit
87 Control unit
88 Display unit

1. An information processing apparatus comprising:
a control unit configured to control to display an image-capturing sample image list in which a plurality of image-capturing sample images captured at a plurality of image-capturing places different from each other is arranged, the control unit being configured to control to present guide information for guidance to an image-capturing place among the image-capturing places, the image-capturing place being of a selected image-capturing sample image among the image-capturing sample images in a case where any of the image-capturing sample images is selected from the image-capturing sample image list.

2. The information processing apparatus according to claim 1, wherein
each of the image-capturing sample images is an image selected on a basis of at least any one of: an estimation value of a degree of preference of a user for the each of the image-capturing sample images; or a priority of each of the image-capturing places determined by a promoter.

3. The information processing apparatus according to claim 2, wherein
a display location or a display size of each of the image-capturing sample images in the image-capturing sample image list is determined by at least any one of the estimation value or the priority.

4. The information processing apparatus according to claim 1, further comprising:
a communication unit configured to transmit image-capturing reservation information for a reservation of image capturing at the image-capturing place of the selected image-capturing sample image among the image-capturing sample images.

5. The information processing apparatus according to claim 4, wherein
the control unit controls to display an image of another user captured at each of the image-capturing places before image capturing of the user, in a case where image capturing of the user at the each of the image-capturing places is reserved.

6. The information processing apparatus according to claim 1, further comprising:
an image-capturing unit configured to capture an environmental image including each of the image-capturing places as a subject, wherein
the control unit controls to display the environment image on which an image indicating a location of the each of the image-capturing places is superimposed.

7. The information processing apparatus according to claim 1, wherein
the guide information is a map indicating a route from a current location of the information processing apparatus to each of the image-capturing places.

8. An information processing method performed by an information processing apparatus, the information processing method comprising:
controlling to display an image-capturing sample image list in which a plurality of image-capturing sample images captured at a plurality of image-capturing places different from each other is arranged, and controlling to present guide information for guidance to an image-capturing place among the image-capturing places, the image-capturing place being of a selected image-capturing sample image among the image-capturing sample images in a case where any of the image-capturing sample images is selected from the image-capturing sample image list.

9. A program for causing a computer to execute processing comprising a step of:
controlling to display an image-capturing sample image list in which a plurality of image-capturing sample images captured at a plurality of image-capturing places different from each other is arranged, and controlling to present guide information for guidance to an image-capturing place among the image-capturing places, the image-capturing place being of a selected image-capturing sample image among the image-capturing sample images in a case where any of the image-capturing sample images is selected from the image-capturing sample image list.

10. An information processing apparatus comprising:
a control unit configured to generate an image-capturing sample image list in which a plurality of image-capturing sample images is arranged on a basis of a plurality of the image-capturing sample images captured at a plurality of image-capturing places different from each other; and
a communication unit configured to transmit, to a terminal device, data for guidance to an image-capturing place among the image-capturing places, the image-capturing place being of a selected image-capturing sample image among the image-capturing sample images in a case where any of the image-capturing sample images is selected from the image-capturing sample image list, in the terminal device that is a transmission destination of the image-capturing sample image list.

11. The information processing apparatus according to claim 10, wherein
the control unit selects an image-capturing sample image among the image-capturing sample images on a basis of at least any one of: an estimation value of a degree of preference of a user for each of the image-capturing sample images; or a priority of each of the image-capturing places determined by a promoter, and the control unit generates the image-capturing sample image list on a basis of the selected image-capturing sample image among the image-capturing sample images.

12. The information processing apparatus according to claim 11, wherein
the control unit determines a display location or a display size of each of the image-capturing sample images in the image-capturing sample image list, on a basis of at least any one of a reference count of each of the image-capturing sample images, a visitor number in each of the image-capturing places based on presentation of each of the image-capturing sample images, a degree of popularity of each of the image-capturing places of each of the image-capturing sample images, the priority, an evaluation value of appearance of each of the image-capturing sample images, a number of persons waiting for image capturing of each of the image-capturing sample images at each of the image-capturing places, a season or a time zone in which each of the image-capturing sample images has been captured, weather at a time of image capturing of each of the image-capturing sample images, a degree of similarity of each of the image-capturing sample images to a predetermined image, or the estimation value.

13. The information processing apparatus according to claim 10, wherein
the control unit controls image capturing by an image-capturing device installed at each of the image-capturing places.

14. The information processing apparatus according to claim 13, wherein
the control unit generates the image-capturing sample image list by using a captured image captured by the image-capturing device as each of the image-capturing sample images.

15. The information processing apparatus according to claim 14, wherein
the control unit gives an incentive to a user corresponding to the selected image-capturing sample image among the image-capturing sample images.

16. The information processing apparatus according to claim 15, wherein
the control unit determines the incentive to be given to the user, on a basis of at least any one of a reference count of each of the image-capturing sample images, a visitor number in each of the image-capturing places based on presentation of each of the image-capturing sample images, or a use result of a service at each of the image-capturing places of another user who has visited the each of the image-capturing places in accordance with presentation of each of the image-capturing sample images.

17. The information processing apparatus according to claim 13, wherein
the communication unit receives image-capturing reservation information transmitted from the terminal device, the image-capturing reservation information being for a reservation of image capturing at the image-capturing place of the selected image-capturing sample image among the image-capturing sample images, and
the control unit makes a reservation for image-capturing on a basis of the image-capturing reservation information.

18. The information processing apparatus according to claim 17, wherein
the communication unit transmits, to the terminal device, a captured image captured by the image-capturing device in accordance with the reservation of image capturing.

19. An information processing method performed by an information processing apparatus, the information processing method comprising:
generating an image-capturing sample image list in which a plurality of image-capturing sample images is arranged on a basis of a plurality of the image-capturing sample images captured at a plurality of image-capturing places different from each other; and
transmitting, to a terminal device, data for guidance to an image-capturing place among the image-capturing places, the image-capturing place being of a selected image-capturing sample image among the image-capturing sample images in a case where any of the image-capturing sample images is selected from the image-capturing sample image list, in the terminal device that is a transmission destination of the image-capturing sample image list.

20. A program for causing a computer to execute processing comprising steps of:
generating an image-capturing sample image list in which a plurality of image-capturing sample images is arranged on a basis of a plurality of the image-capturing sample images captured at a plurality of image-capturing places different from each other; and
transmitting, to a terminal device, data for guidance to an image-capturing place among the image-capturing places, the image-capturing place being of a selected image-capturing sample image among the image-capturing sample images in a case where any of the image-capturing sample images is selected from the image-capturing sample image list, in the terminal device that is a transmission destination of the image-capturing sample image list.
